(19) United States
(12) Patent Application Publication
(10) Pub. No.: US 2006/0040088 A1
(43) Pub. Date: Feb. 23, 2006

(54) Information reproduction method and information recording medium

(76) Inventors: Akemi Hirotsune, Saitama (JP); Hiroyuki Minemura, Kokubunji (JP); Yumiko Anzai, Ome (JP); Toshimichi Shintani, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/931,085

(22) Filed: Sep. 1, 2004

(30) Foreign Application Priority Data
Aug. 23, 2004 (JP) 2004-242064

(51) Int. Cl. B32B 3/02

(52) U.S. Cl. 428/64.4

(57) ABSTRACT

Disclosed are an information reproduction method and an information recording medium that allow reproducing information below a diffraction limit. A recording layer formed with recording marks consisting of a nucleation inducer and a reading layer are provided. When a reading beam is irradiated, a predetermined area of the reading layer is crystallized based on the recording mark of the recording layer such that the area is magnified to a size larger than the recording mark, and information is thus reproduced. Information of the recording marks below the diffraction limit can be reproduced without using a special information reproduction apparatus.

### CLAIM OF PRIORITY

The present application claims priority from Japanese application JP 2004-242064 filed on Aug. 23, 2004, the content of which is hereby incorporated by reference into this application.

### FIELD OF THE INVENTION

The present invention relates to an information reproduction method and an information recording medium used for an optical disk.

### BACKGROUND OF THE INVENTION

A variety of principles are known for recording information on a thin film (recording film) by means of irradiating a laser. Among them, a principle that an atomic arrangement is changed by laser irradiation as in phase-change (also called as phase-transition and phase-transformation) of a film material has come to be used.

Generally, information recording media are composed of a first protective layer, a recording film made of GeSbTe type material and the like, an upper protective layer, and a reflective layer. Recording is conducted by making the recording film amorphous and erasing is conducted by making it crystalline by irradiating light, respectively. A minimum mark size is determined by the diffraction limit of a spot.

As methods for reproducing a mark below the diffraction limit, a method to utilize super resolution or magnifying magnetic domain is known so far. For example, a GeSbTe film and the like are used as a super resolution reading layer in JP-A NO. 269627/1998 (patent document 1). This document discloses that minute marks are read by forming an optical aperture smaller than a spot size by heat of a laser. Further, JP-A No. 295479/1994 (patent document 2) and JP-A No. 087041/2004 (patent document 3) disclose a method so-called MAMMOS (magnetic amplifying magneto-optical system) in which recording magnetic domain is formed on a magnifying reading layer by magnetic transcription and the recording magnetic domain is magnified to the limit of a spot size of a reading light by the reading light irradiated from a reading light-irradiating unit.
[patent document 1] JP-A NO. 269627/1998
[patent document 2] JP-A No. 295479/1994
[patent document 3] JP-A No. 087041/2004

### SUMMARY OF THE INVENTION

Although reproducing methods that utilize the above super resolution and magnifying magnetic domain are capable of reading marks below the diffraction limit, each method has the following problems.

The method disclosed in patent document 1 that makes use of super resolution presents a problem that the amount of reading signals is decreased and SNR of reading signals becomes low because the optical aperture becomes smaller than the spot size.

The MAMMOS method disclosed in patent documents 2 and 3 presents a problem that it is difficult to construct an apparatus to read both reflective signals and magnetic signals because the apparatus not only requires a magnet and is complex but also does not simply read signals from reflective changes based on projections and depressions as ROM does.

The above problems were solved by the following way. That is, a principle of magnifying reading in which a recording layer and a reading layer are provided and a predetermined area of the reading layer is magnified to a size larger than a recording mark based on the recording mark in the recording layer is employed. There are three kinds of methods for the magnifying reading as described below:

(1) Recording marks consisting of a nucleation inducer are formed in the recording layer. The reading layer is changed from amorphous to crystalline in an area corresponding to the recording mark by being irradiated with a light beam, and a magnified mark is formed there. When the magnified mark is formed, a reflective change occurs, thereby allowing information reproduction.

This principle is explained using FIGS. 1 and 2. FIG. 1 is a diagram of information reproduction according to (1). First, recording marks 4 consisting of a nucleation inducer and a reading layer 5 in contact with the recording marks 4 are formed. As to the size of the recording marks 4 in the spot traveling direction, a length of the shortest mark is below the diffraction limit. The reading layer is changed from amorphous to crystalline when reaching the crystallization temperature, and forms a magnified mark 7. As shown in FIG. 2, the reading layer has a property that crystallization occurs from a lower temperature when in contact with the nucleation inducer (recording mark) compared to when not in contact with the nucleation inducer (recording mark). Owing to this property, when a spot 1 is focused on the recording mark 4 and the reading layer 5 of an information recording medium and the reading layer 5 is heated up to a magnifying reading temperature 11, the reading layer in an amorphous state is crystallized centering the recording mark. Thus, a magnified crystalline area (magnified mark) 7 is formed in the spot, and a reflective change occurs in the area above the diffraction limit. This reflective change in the crystalline area (magnified mark) 7 is detected as a reading signal, thereby making it possible to read the recording mark below the diffraction limit.

An advantage of the method in (1) is that a laser power at the time of magnifying reading can be made low because the magnifying reading temperature is low compared to the methods in (2) and (3). A lower laser power at the time of magnifying reading allows a less expensive low-power laser to be used for a reproduction apparatus.

(2) The recording marks consisting of a crystalline material are formed in the recording layer. The reading layer is changed from amorphous to crystalline in an area corresponding to the recording mark by being irradiated with a light beam, and a magnified mark is formed there. When the magnified mark is formed, a reflective change occurs, thereby allowing information reproduction.

This principle is explained using FIGS. 11 and 12. FIG. 11 is a diagram of information reproduction according to (2). First, recording marks 104 consisting of a crystalline material and a reading layer 105 in contact with the recording marks 104 are formed. As to the size of the recording marks 104 in the spot traveling direction, a length of the shortest mark is below the diffraction limit. The reading layer 105 is changed from amorphous to crystalline when reaching the crystallization temperature and forms a magnified mark 7. As shown in FIG. 12, the reading layer has a property that crystallization occurs from a lower temperature when in contact with the crystal (recording mark) compared to when not in contact with the crystal (recording mark). Owing to this property, when a spot 1 is focused on the recording mark 104 and the reading layer 105 of an information recording medium and the reading layer 105 is heated up to a magnifying reading temperature 111, the reading layer in an amorphous state is crystallized centering the recording mark. Thus, a magnified crystalline area (magnified mark) 107 is formed in the spot, and a reflective change occurs in the area above the diffraction limit. This reflective change in the crystalline area (magnified mark) 107 is detected as a reading signal, thereby making it possible to read the recording mark below the diffraction limit.

An advantage of the method in (2) is that it can be used for magnifying reading of not only ROM and WO (write once) but also RAM (rewritable type) by using a phase-change material that changes between crystalline and amorphous states for a recording film because the recording marks are crystalline. A laser power at the time of magnifying reading can be made low compared to that for the method in (3), and a less expensive low-power laser can be used for a reproduction apparatus.

(3) The recording marks with larger absorption than that in non-recording area are formed in the recording layer. The reading layer is changed from crystalline to melt (amorphous) in an area corresponding to the recording mark by being irradiated with a light beam, and a magnified mark is formed there. At this time, the area in the reading layer corresponding to the recording mark is melted by heat conduction from the recording mark. When the magnified mark is formed, a reflective change occurs, thereby allowing information reproduction.

This principle is explained using FIGS. 18 and 19. FIG. 18 is a diagram of information reproduction according to (3). First, recording marks 174 with larger absorption and a reading layer 175 are formed. As to the size of the recording marks 174 in the spot traveling direction, a length of the shortest mark is below the diffraction limit. The reading layer is changed from crystalline to melt, i.e., amorphous, when reaching the melt temperature and forms a magnified mark 177. As shown in FIG. 19, the reading layer 175 has a property that its temperature rises in the area with larger absorption (recording mark) compared to the area with smaller absorption (other than recording mark) and amorphousization occurs from a lower read power. Owing to this property, when a spot 1 is focused on the recording mark 174 and the reading layer 175 of the information recording medium and the reading layer 175 is irradiated with a magnifying reading power 181, the reading layer in a crystalline state is amorphousized, centering the recording mark. Thus, a magnified amorphous area (magnified mark) 177 is formed in the spot, and a reflective change occurs in the area above the diffraction limit. This reflective change in the amorphous area (magnified mark) 177 is detected as a reading signal, thereby making it possible to read the recording mark below the diffraction limit.

There are two advantages in the method described in (3). One advantage is that reading is hardly influenced by an environmental temperature because a high magnifying reading power is used. The other advantage is that a process for preparing reading (crystallization) is unnecessary prior to the next magnifying reading because the reading layer crystallizes once the spot passes and the reading power is not irradiated to the reading layer any more.

According to the present invention, a medium with recording marks below the diffraction limit can be reproduced with a simple apparatus.

### BRIEF DESCRIPTION OF THE DRAWINGS

FIG. 1 is a diagram of a first embodiment according to the present invention;

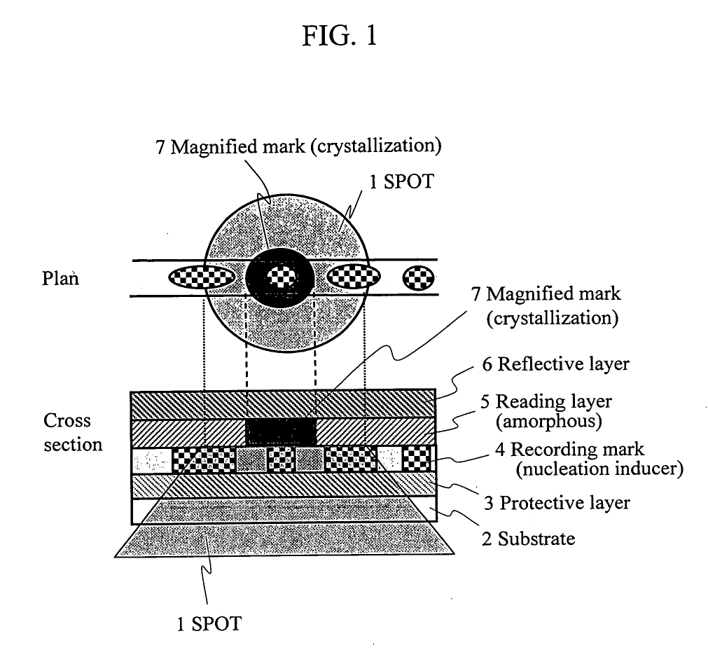

FIG. 2 represents a crystallization characteristic of a reading layer of the first embodiment according to the present invention;

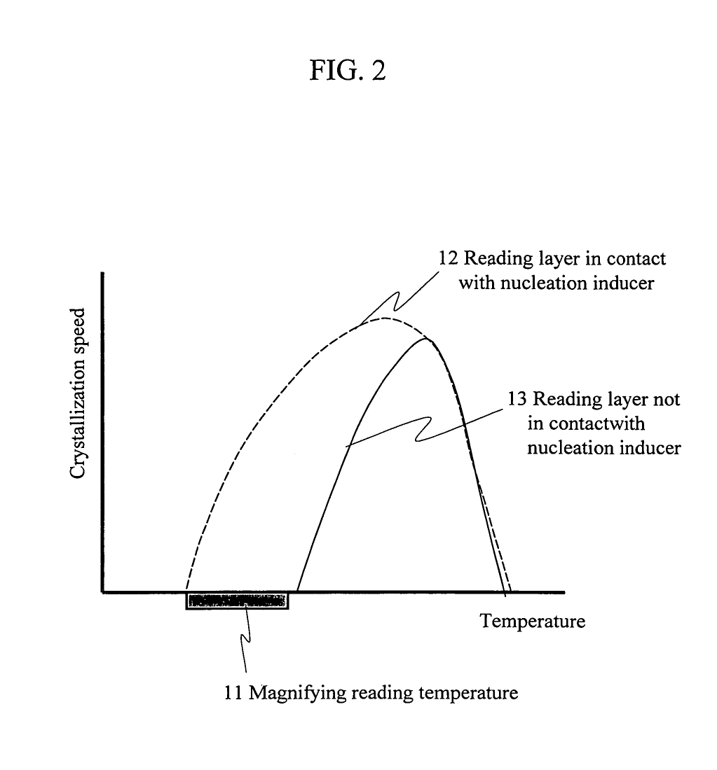

FIG. 3 is a cross section of a medium of the first embodiment according to the present invention;

FIG. 4 represents medium manufacturing processes of the first embodiment according to the present invention;

FIG. 5 is a schematic drawing of recording waveforms;

FIG. 6 is a schematic drawing of an information reproduction apparatus according to the present invention;

FIG. 7 shows spot arrangement of the information reproduction apparatus according to the present invention, where FIG. 7A is one example of the spot arrangement, FIG. 7B is another example of the spot arrangement, FIG. 7C is still another example of the spot arrangement, FIG. 7D is still another example of the spot arrangement, FIG. 7E is still another example of the spot arrangement, and FIG. 7F is still another example of the spot arrangement.

FIG. 8 depicts a reading characteristic of the first embodiment according to the present invention;

FIG. 9 is a cross section of a medium of a second embodiment according to the present invention;

FIG. 10 represents medium manufacturing processes of the second embodiment according to the present invention;

FIG. 11 is a diagram of a third embodiment according to the present invention;

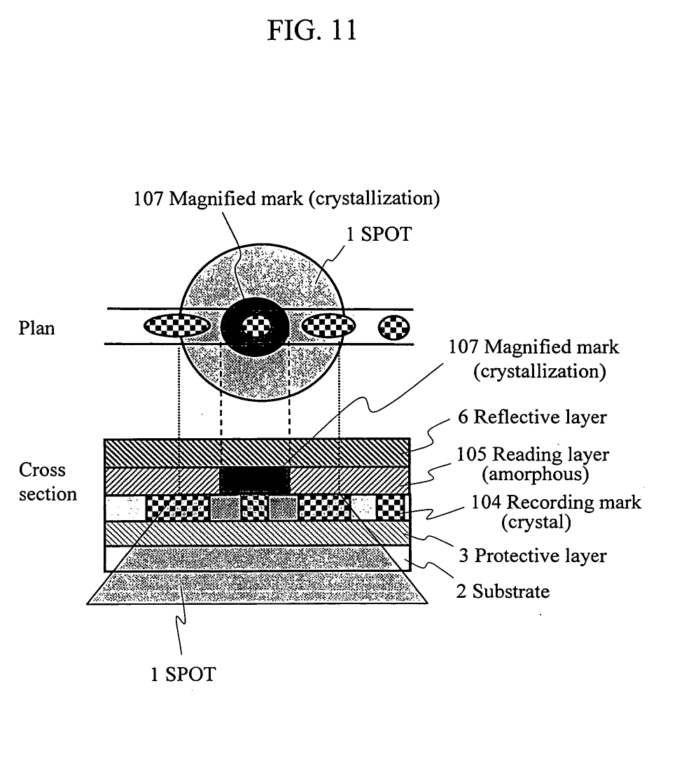

FIG. 12 represents a crystallization characteristic of a reading layer of the third embodiment according to the present invention;

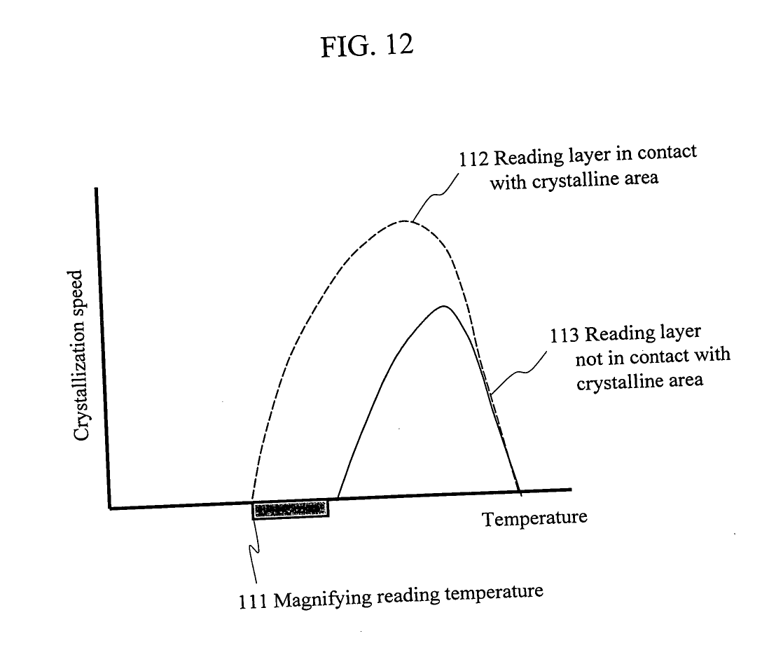

FIG. 13 is a cross section of a medium of the third embodiment according to the present invention;

FIG. 14 is a cross section of a medium of a fourth embodiment according to the present invention;

FIG. 15 is a cross section of a medium of a fifth embodiment according to the present invention;

FIG. 16 represents medium manufacturing processes of the fifth embodiment according to the present invention;

FIG. 17 represents a reading characteristic of the third embodiment according to the present invention;

FIG. 18 is a diagram of a sixth embodiment according to the present invention;

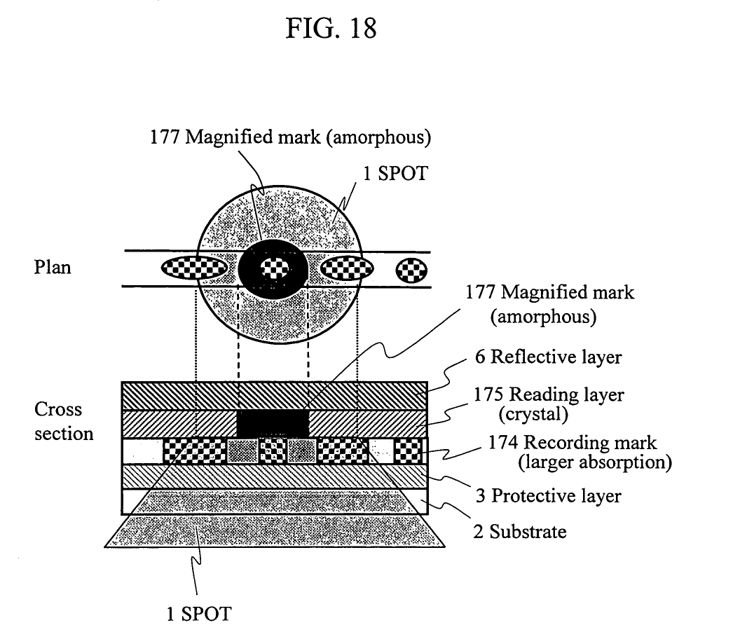

FIG. 19 represents a reflective characteristic of a reading layer of the sixth embodiment according to the present invention;

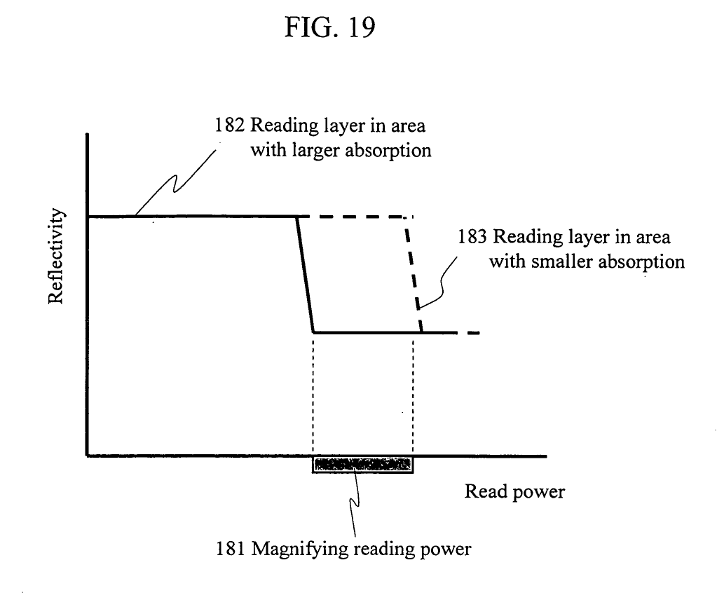

FIG. 20 is a cross section of a medium of the sixth embodiment according to the present invention;

FIG. 21 represents a reading characteristic of the sixth embodiment according to the present invention;

FIG. 22 is a cross section of a medium of a seventh embodiment according to the present invention;

FIG. 23 is a cross section of a medium of an eighth embodiment according to the present invention;

FIG. 24 is a diagram of a ninth embodiment according to the present invention;

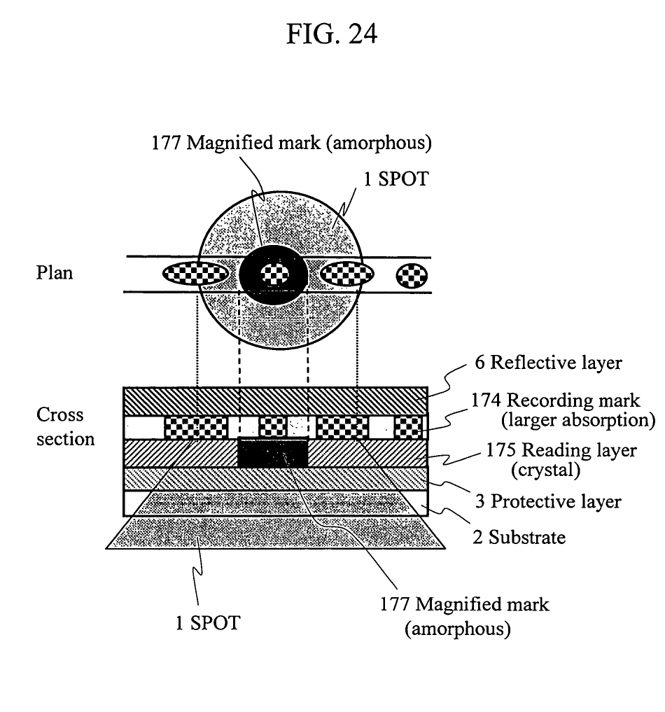

FIG. 25 is a cross section of a medium of the ninth embodiment according to the present invention;

FIG. 26 is a cross section of a medium of a tenth embodiment according to the present invention;

FIG. 27 is a cross section of a medium of an eleventh embodiment according to the present invention;

FIG. 28 is a diagram of a twelfth embodiment according to the present invention;

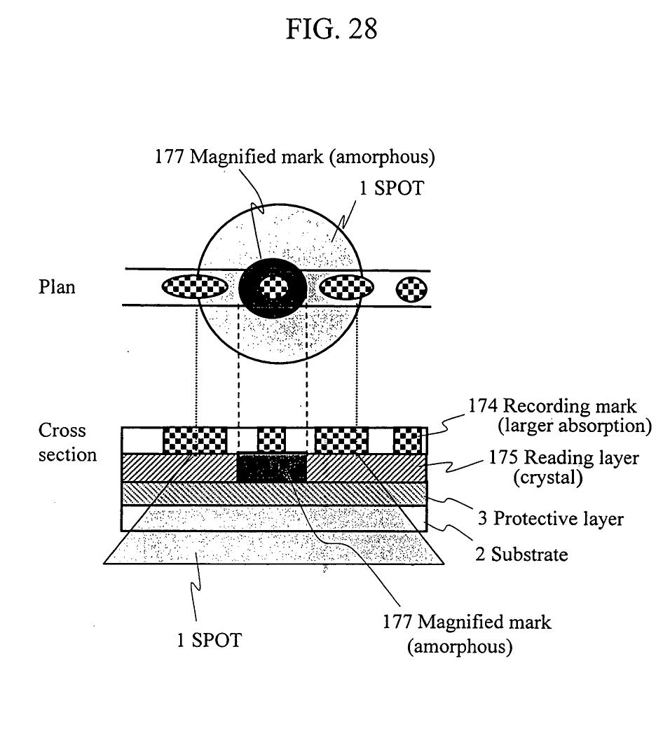

FIG. 29 is a cross section of a medium of the twelfth embodiment according to the present invention;

FIG. 30 is a cross section of a medium of a thirteenth embodiment according to the present invention;

FIG. 31 is a cross section of a medium of a fourteenth embodiment according to the present invention;

FIG. 32 is a cross section of a medium of a fifteenth embodiment according to the present invention;

FIG. 33 is a cross section of a medium of a sixteenth embodiment according to the present invention;

FIG. 34 is a cross section of a medium of a seventeenth embodiment according to the present invention;

FIG. 35 is a cross section of a medium of an eighteenth embodiment according to the present invention;

FIG. 36 is a cross section of a medium of a nineteenth embodiment according to the present invention;

FIG. 37 is a cross section of one example of conventional information recording media; and

FIG. 38 is a cross section of another example of conventional information recording media.

### DETAILED DESCRIPTION OF THE PREFERRED EMBODIMENTS

Hereinafter, the present invention is explained in detail by means of the following embodiments.

### First Embodiment

A first embodiment in which magnified marks are formed in a reading layer based on ROM recording marks composed of a nucleation inducer as described above in (1) is explained.

(Composition and Manufacturing Method of Information Recording Medium of the Present Invention)

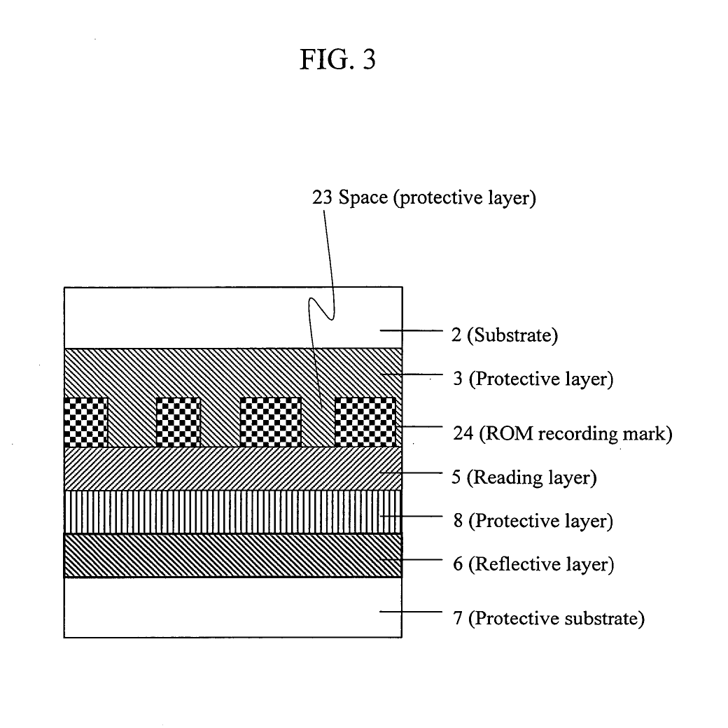

FIG. 3 depicts a cross sectional structure of a disk-shaped information recording medium of the first embodiment of the present invention. This medium was manufactured as follows:

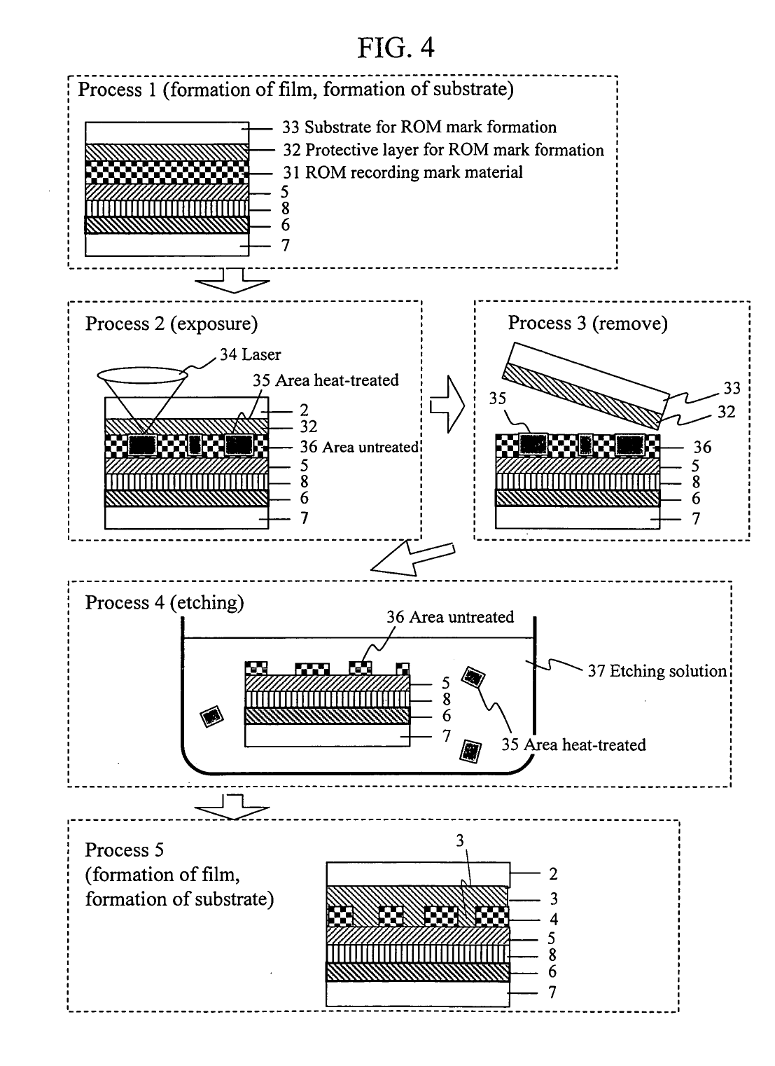

The processes for manufacturing the medium are shown in FIG. 4. First, in Process 1, a reflective layer 6 made of Ag₉₈Pd₁Cu₁ with a thickness of 200 nm, a protective layer 8 made of Cr₂O₃ with a thickness of 20 nm, a reading layer 5 made of Ge₆Sb₂Te₉ with a film thickness of 10 nm, a ROM recording mark material 31 made of Bi—Te—N with a film thickness of 20 nm, and a protective layer for ROM mark formation 32 made of SiO₂ with a thickness of 20 nm were formed in turn by sputtering over a polycarbonate protective substrate 7 having a diameter of 12 cm, a thickness of 1.1 mm, and grooves for tracking of land-groove recording with a track pitch of 0.2 μm on its surface. Then, a substrate for ROM mark formation 33 was formed with a thickness of 0.1 μm by spin coating an ultraviolet light curing resin.

In Process 2, the ROM recording mark material 31 was locally heat-treated by recording pulses corresponding to recording information in an information recording apparatus. The wavelength of the laser of the information recording apparatus is 405 nm, and the number of aperture is 0.85. Accordingly, the spot size of the light is 414 nm from (λ/NA)·0.87. By controlling recording power and pulse, only the central part of the spot with a high heat was arranged to irradiate the ROM recording mark material 31. The linear velocity employed was 5 m/s. Here, the treatment was carried out so that an area heat-treated 35 became a space and an area untreated 36 became a mark.

Varying the mark size from 170 nm that exceeds a diffraction limit to 40 nm that is below the diffraction limit, recording was successively carried out.

Then, as shown in Process 3 and 4, the information recording medium was separated between the ROM recording mark material 31 and the protective layer for ROM mark formation 32, and the lower portion was immersed in an alkaline etching solution for one hour to perform an etching treatment. By this treatment, only the area heat-treated 35 was etched and removed. In this way, ROM marks 24 were formed.

Then, a protective layer 3 made of ZnSSiO₂ with a thickness of 30 nm was formed by sputtering as shown in Process 5. A space 23 was formed by a deposit of the material for the protective layer in a space between the ROM marks 24 when the protective layer 3 was formed. Subsequently, a substrate 2 of an ultraviolet light curing resin with a thickness of ca. 0.1 μm was formed by spin coating.

The laser having a wavelength of 405 nm and an aperture number of 0.85 was used for the ROM mark formation here in Process 2. A laser having a shorter wavelength and a larger number of apertures may also be used for recording, and the heat treatment at a different linear velocity may also be carried out.

The heat treatment may be performed with placing the ROM recording mark material as an outermost surface without forming the substrate for ROM mark formation and the protective layer for ROM mark formation. In this case, a method of heating by an electron beam irradiation or by a local electric current may also be employed besides the laser irradiation.

Although the heat treatment was carried out here such that the area heat-treated 35 becomes a space and the area untreated 36 becomes a mark, the treatment may also be carried out such that the area heat-treated serves as a mark. In this case, the area untreated can be removed by varying the concentration and the kind of the etching solution, and therefore, the ROM recording mark 24 can be formed in a similar way as above.

(Method for Preparing Magnifying Reading)

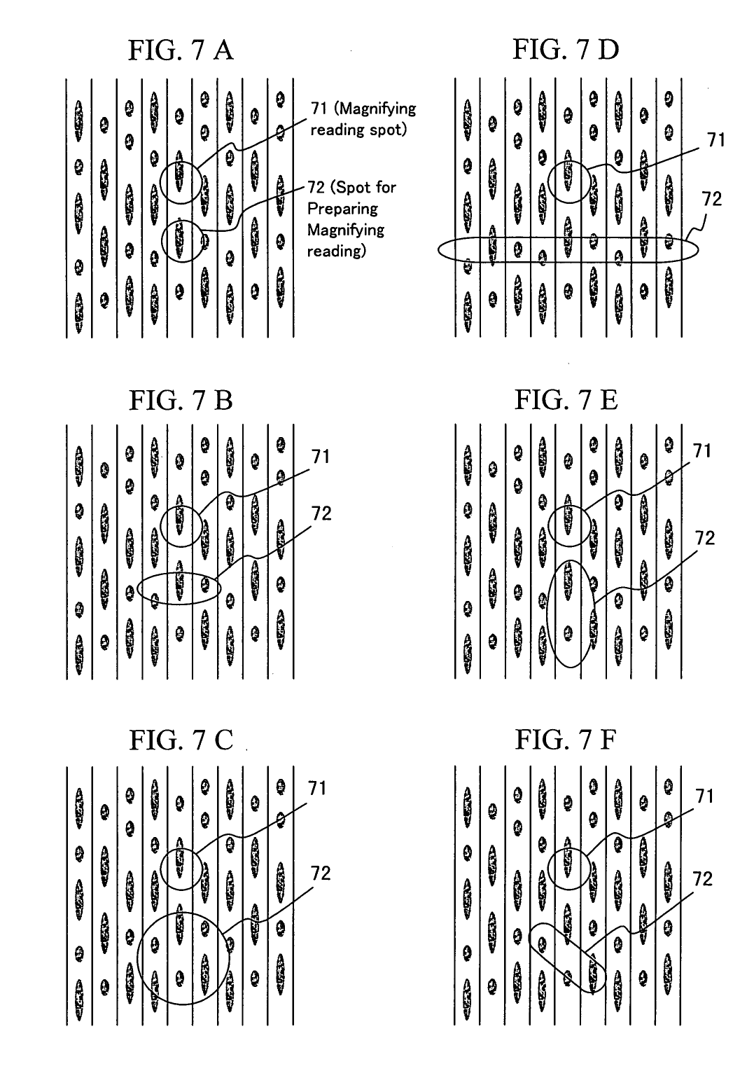

The reading layer 5 of the disk prepared as described above was subjected to an initial amorphousization in the following way. The information recording medium disk was rotated at a linear velocity of 5 m/s, and the reading layer 5 was irradiated by a 5 mW pulse light with a width less than one half the detection window width to carry out an initial amorphousization. In addition to the initial amorphousization, a spot for preparing magnifying reading 72 is provided either at the front or the back of the traveling direction of a magnifying reading spot 71 to make it possible to amorphousize it by irradiating a laser before or after information reproduction and prepare for magnifying reading as shown in FIGS. 7A to 7F. Thus, by providing the spot for preparing magnifying reading 72 besides the magnifying reading spot, the amorphousization conversion can be performed almost at the same time as the reproduction, thereby rendering it unnecessary to irradiate a laser again for preparing for reproduction. Further, when spots that can be irradiated by a laser are prepared on both sides of the track of the magnifying reading spot 71 as shown in FIGS. 7B, 7C, 7D, and 7F, amorphousization becomes possible for both sides of the track, leading to a reduction of crosstalk from tracks on both sides. When a long spot in the traveling direction of the magnifying reading spot is prepared, amorphousization could be carried out even by a low power.

(Information Reproduction Method and Information Reproduction Apparatus)

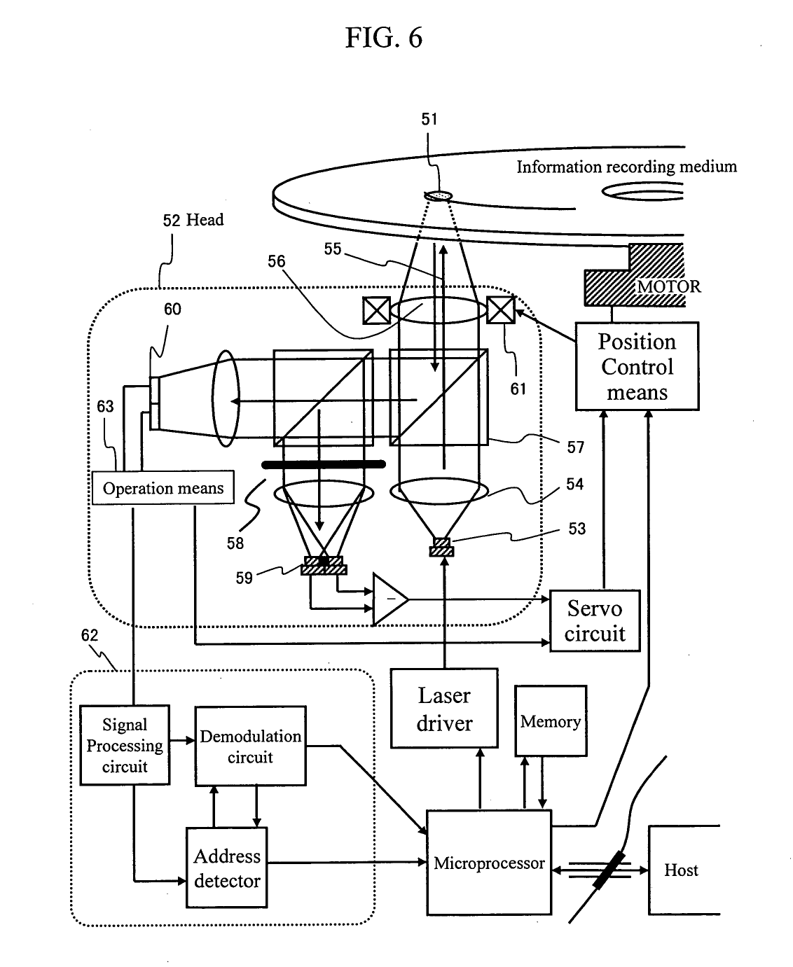

FIG. 6 is a block diagram of an apparatus of information reproduction.

The light emitted from a laser source 53 (Blue-ray of wavelength of ca. 410 nm) that is part of a head 52 is collimated to a parallel light beam 55 through a collimating lens 54. The light beam 55 is irradiated on an optical information recording medium through an objective lens 56, forming a spot 51 on the information recording medium. Then, the light is led to a servo detector 59, a signal detector 60 via a beam splitter 57, a hologram element 58, and the like. Signals from each detector are added or subtracted to serve as servo signals such as tracking error signal and focus error signal, and input to a servo circuit. The servo circuit controls an actuator 61 for the objective lens 56 and the position of the whole light head 52, and positions the light spot 51 to an objective recording and reading area. The signal added by the detector 60 is input to a signal reading block 62. The input signal is subjected to a filtering process, frequency equalizing process, and analog/digital converting process by a signal processing circuit. The digitalized signal through the analog/digital process is processed by the address detector and a demodulation circuit. A microprocessor computes a position of the light spot 51 on the information recording medium based on an address signal detected by the address detector and controls a position control means, thereby allowing the light head 52 and the light spot 51 to be positioned to an objective recording unit area (sector).

When the instruction from the host to the information recording and reproduction apparatus is recording, the microprocessor receives the record data from the host and stores them in a memory. Further, the microprocessor controls the position control means to position the light spot 51 to the objective recording area. After the microprocessor confirmed that the light spot 51 was correctly positioned to the recording area by an address signal from the signal reading block 62, it records data in the memory in the objective recording area by controlling a laser driver and the like.

Recording and reading of information were carried out for the above information recording medium with the use of the information reproduction apparatus. The operation of this information reproduction apparatus is explained below. It should be noted that ZCAV (zoned constant linear velocity) system in which the number of revolutions of a disk is changed for every zone of record reading was used for a method of controlling a motor at the time of record reading. The linear velocity for the disk is about 5 m/s.

When information is recorded in the disk, 1-7 PP modulation method was used for the recording. Information from the outside of the recording apparatus is transmitted to a modulator with 8 bits as a unit. In this modulation method, information recording is performed with recording mark lengths of 2T to 9T that correspond with 8-bit information. Note that T represents clock period at the time of information recording, and it was 7.1 ns here.

The digital signals of 2T to 9T modulated by the modulator are transmitted to a recording waveform-generating circuit. In the above recording waveform-generating circuit, the signals of 2T to 9T are made correspondent to “0” and “1” alternately in time sequence. When the signal is “0”, a laser power is irradiated at a bottom power level, and when the signal is “1”, a high power pulse or pulse train is irradiated.

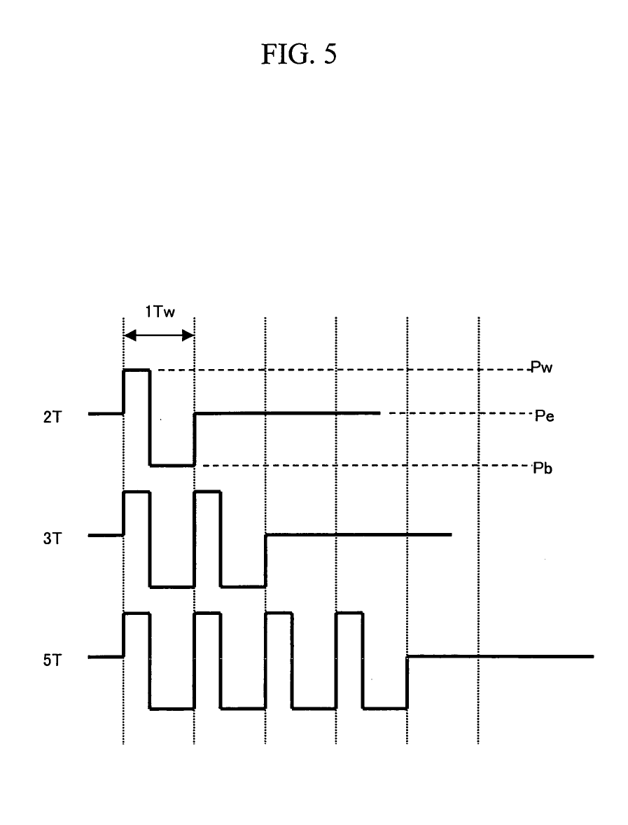

An example of the recording pulses is shown in FIG. 5. The width of the high power pulse is about 2Tw/2 to Tw/2. When a recording mark exceeding 3T is formed, a pulse train consisting of a plurality of pulses with a high power level (Pw) is used. In the portion between two pulses in the pulse train where no recording mark is formed, an intermediate power level (Pe) or a further lower power level (Pb) was used. The recording pulses are formed by these combinations. Here, the high power level was set to 5 mW. The intermediate power level was set to 1 mW, and the low power level was set to 0.5 mW. The recording pulses shown here represent merely one example, and other forms and levels may be employed for the recording pulses.

In this way, no change occurs in the area of the optical disk irradiated by a laser beam with a low power level, while the area irradiated by a pulse train with a high power level is heat-treated.

The above recording waveform-generating circuit has a multi-pulse waveform table that corresponds to a system to change a front pulse width and an end pulse width of the multi-pulse waveform (adaptive recording waveform control) according to the length of space at the front and the back of a mark portion at the time when a series of high power pulse train is formed to make the mark portion. By this means, a multi-pulse recording waveform that can exclude an effect of heat interference occurring between marks is generated.

In the present embodiment, recording was also carried out by the present information reproduction apparatus; magnifying reading is possible without having a recording function in the information reproduction apparatus. Further, information recording may be performed with an apparatus other than the present information reproduction apparatus.

(Information Reproduction Method of the Present Invention)

When magnifying reading is conducted, a reading power is enhanced from a reading light to perform a focus tracking (Pf) to a magnifying reading power (Pr1) to crystallize the reading layer and allow to change its reflectivity. Since the reading layer of the present embodiment has a crystallization characteristic that it starts to crystallize from 130 degrees C. when in contact with a nucleation inducer, while it starts to crystallize from 200 degrees C. when not in contact with the nucleation inducer, its magnifying reading temperature should be at a temperature higher than 130 degrees C. and lower than 200 degrees C.

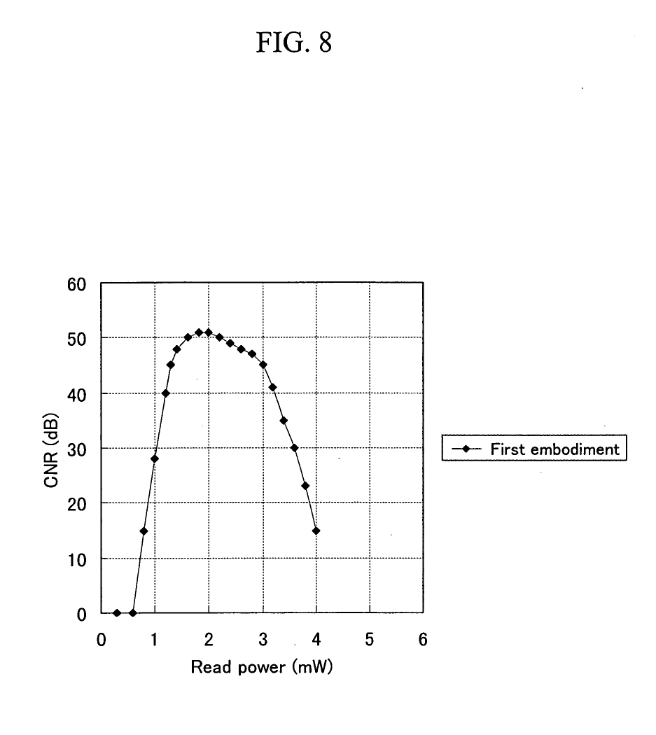

The ROM mark with a recording mark size of 80 nm that was below the diffraction limit was read. The Pf was set to 0.3 mW. When CNR of the reading mark was examined while changing the magnifying reading power (Pr1), reading results as shown in FIG. 8 were obtained. When the Pr1 was 0.3 mW that was the same as the Pf, no signal from the mark could be detected. When the Pr1 was 1.2 mW that was higher than the Pf, a CNR of 40 dB was obtained. At 1.3 mW, 45 dB was obtained. A maximal CNR obtained was 51 dB. When the magnifying reading is conducted by shifting to a further higher power, 45 dB and 41 dB were obtained at 3 mW and 3.2 mW, respectively. Stable tracking can be conducted at the reading power for focus tracking ranging from 0.2 mW to 0.5 mW.

The relation between the reading power for focus tracking (Pf) and the magnifying reading power (Pr1) that gives an excellent magnifying reading characteristic was found to be expressed as below.
2×Pf≦Pr1
   (Comparison with a Conventional Example)

Next, the effect of magnifying reading was examined in comparison with a conventional example while changing the mark size, and the result is shown in Table 1. The effect of the magnifying reading represents the difference between both reading results.

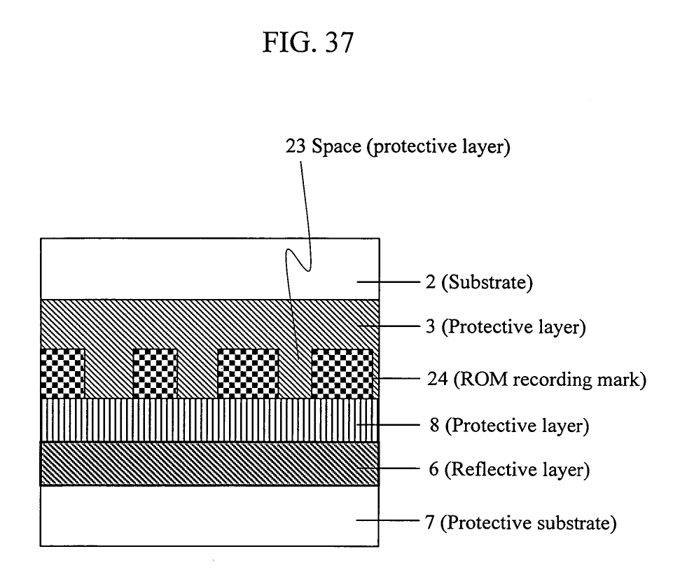

A ROM disk in which there is no reading layer and the mark size is changed by pits and projections was used for the conventional example. The structure of the conventional medium is shown in FIG. 37.

TABLE 1

| Mark | Reading result of | Magnifying reading | Effect of |
|---|---|---|---|
| size | conventional example | result of the invention | magnifying |
| (nm) | (dB) | (dB) | reading (dB) |
| 170 | 55 | 54 | −1 |
| 150 | 55 | 54 | −1 |
| 130 | 53 | 54 | 1 |
| 120 | 10 | 54 | 44 |
| 100 | No signal detected (0) | 53 | 53 |
| 80 | No signal detected (0) | 51 | 51 |
| 60 | No signal detected (0) | 45 | 45 |
| 40 | No signal detected (0) | 40 | 40 |

From the above it is found that the effect of magnifying reading is prominent at 100 nm or lower where the mark size becomes smaller than the diffraction limit.

In addition, when the size was examined where the recording mark was magnified, the magnifying recording mark size in the spot traveling direction did not become larger than the spot size.

(Composition of Reading Layer 5)

When CNR of signals from the disk in the first embodiment having a mark size set to 80 nm was measured while varying the material for the reading layer 5, the result shown in Table 2 was obtained. The CNR shown here represents a maximum value within magnifying reading power. A range of the magnifying reading power showing a CNR equal to or higher than 40 dB was shown.

TABLE 2

| Material for | CNR | Magnifying reading |
|---|---|---|
| reading layer | (dB) | power (mW) |
| Ge—Sb—Te | 51 | 1.2-3.2 |
| Ge—Bi—Te | 50 | 1.1-3.2 |
| Ge—Bi—Sb—Te | 49 | 1.2-3.4 |
| Ag—In—Sb—Te | 48 | 1.0-3.1 |
| Ag—In—Ge—Sb—Te | 47 | 1.1-3.1 |
| Ge—Te | 45 | 1.5-3.3 |
| Ge—Sb—Te—O | 41 | 1.0-1.2 |
| Ge—Sb—Te—N | 41 | 1.3-1.5 |
| Sb | 30 | — |
| Ag—Sb | 15 | — |
| Bi—Sb | 10 | — |
| Ag—Te | No signal detected (0) | None |
| No reading layer | No signal detected (0) | None |

From this result, it was found that the recording mark is magnified and that an excellent signal having a CNR equal to or higher than 40 dB is obtained when Ge—Sb—Te, Ge—Bi—Te, Ag—In—Ge—Sb—Te, Ge—Te, Ag—In—Sb—Te, Ge—Bi—Sb—Te, Ge—Sb—Te—O, and Ge—Sb—Te—N were used as the material for the reading layer. Among them, Ge—Sb—Te, Ge—Bi—Te, Ag—In—Ge—Sb—Te, Ge—Te, Ag—In—Sb—Te, and Ge—Bi—Sb—Te gave a CNR equal to or higher than 45 dB and were more desirable.

Further, Ag—In—Sb—Te and Ge—Sb—Te—O were found to have good reading sensitivity at lower reading power. Furthermore, it was found that Ge—Bi—Te and Ge—Bi—Sb—Te have a range of magnifying reading larger than 3.1 mW, respectively, and that their stability in magnifying reading is excellent. Further, when the contents (atomic %) of Te in the reading layer were varied in the measurement of CNR, excellent signals with CNR equal to or higher than 45 dB were obtained when the contents of Te were 15 atomic % or higher and 60 atomic % or lower.

An effect of magnifying reading similar to the above result was also observed for phase-change materials not described here that are materials of a type having a property of nucleation and crystallization.

It should be noted that “no reading layer” in Table 2 means that the measurement was conducted with an information recording disk with formed recording marks, which differs from the conventional example described above.

When the content of any constituent element of the reading layer deviated by 3 atomic % or more from the above compositions, crystallization speed became too fast or too slow, giving rise to a problem that shapes of magnified marks were distorted. Accordingly, impurity elements are preferably less than 3 atomic %, and more preferably less than 1 atomic %.

(Composition of Nucleation Inducer)

When CNR of signals from the disk in the first embodiment having the mark size set to 80 nm was measured while varying the material for the ROM recording mark material (nucleation inducer) 31, the result shown in Table 3 was obtained.

TABLE 3

| Nucleation inducer | CNR (dB) |
|---|---|
| Bi—Te—N | 51 |
| Sn—Te—N | 50 |
| Ge—N | 49 |
| Ge—Cr—N | 48 |
| Bi—Te | 48 |
| Ta—N | 45 |
| Ta—O—N | 43 |
| Si—O—N | 43 |
| Sn—Te | 46 |
| Bi—Sb | 47 |
| Cr—O | 42 |
| Sn—O | 41 |
| Ta—O | 40 |
| Bi | 40 |
| Te | No signal detected (0) |
| Sb | No signal detected (0) |

From this result, it was found that the recording mark is magnified and that an excellent signal having a CNR equal to or higher than 40 dB is obtained when recording marks are formed using as the nucleation inducer Bi—Te—N, Sn—Te—N, Ge—N, Ge—Cr—N, Ta—N, Ta—O—N, Sn—Te—N, Si—O—N, Sn—Te, Bi—Te, Bi—Sb, Cr—O, Sn—O, Ta—O, and Bi.

Further, when the contents (atomic %) of Te and N in Bi—Te—N were varied in the measurement of CNR, the following result was obtained.

TABLE 4

| Te | N | Sum of Te and N | CNR |
|---|---|---|---|
| (Atomic %) | (Atomic %) | (Atomic %) | (dB) |
| 0 | 0 | 0 | 40 |
| 10 | 0 | 10 | 42 |
| 20 | 0 | 20 | 45 |
| 42 | 0 | 42 | 46 |
| 60 | 0 | 60 | 48 |
| 62 | 0 | 62 | 45 |
| 15 | 5 | 20 | 45 |
| 54 | 10 | 64 | 51 |
| 49 | 18 | 67 | 49 |
| 43 | 28 | 71 | 45 |
| 100 | 0 | 100 | No signal detected |

From this result, it was found that excellent signals with CNR equal to or higher than 45 dB were obtained when the contents of Te and N were 20 atomic % or higher and 71 atomic % or lower, respectively, for the Te—N-containing material. When N was absent in the material, excellent signals with CNR equal to or higher than 45 dB were found to be obtained when the content of Te was between 15 and 60 atomic %.

The effect of magnifying reading similar to the above result was also observed even with nucleation inducers not described here.

(Composition of Protective Layer for ROM Mark Formation 32)

Even when SiO₂ in the protective layer for ROM mark formation 32 was replaced with any of Al₂O₃, MgO, MgF₂, and a mixture thereof, the process shown in FIG. 4 could be carried out.

(Composition of Protective Layer 8)

Even when Cr₂O₃ in the protective layer 8 was replaced with any material of SnO₂, ZnS—SiO₂, Ta—O, and a mixture thereof, similar results were obtained.

The effect of magnifying reading similar to the above result was observed even with materials for the protective layer not described here.

Even though the protective layer 8 was not formed, the effect of magnifying reading can be obtained. However, magnifying readable cycle is lowered by two orders of magnitude.

(Composition of Reflective Layer 6)

Even when AgPdCu in the reflective layer 6 was replaced with any of Ag compounds, Al compounds, Au compounds, Cr compounds, and a mixture thereof, a similar result was obtained.

The effect of magnifying reading similar to the above result was also observed even with materials for the reflective layer not described here.

Even though the reflective layer 6 was not formed, the effect of magnifying reading can be obtained. However, heat generated at the time of heat treatment to form the recording mark tends to be trapped in this case, giving rise to variations in forming small recording marks and reduction in CNR by ca. 5 dB.

(Substrate)

In the present embodiment, the polycarbonate substrate 7 having grooves for tracking is used for a protective substrate. “Substrate having grooves for tracking” means a substrate having grooves deeper than λ/12n′ (n′ is the refractive index of a substrate material) on the whole surface of the substrate or part of its surface when the recording-reading wavelength is λ. The groove may be formed seamlessly in a circle or divided in its tracks. When the depth of the groove was about λ/6n, its crosstalk was found to be desirably reduced. In addition, the width of the groove may differ depending on places. The substrate may be the one having a format by which recording and reading can be conducted in both groove and land or the one having a format by which recording is conducted in either one of the groove or land. Further, materials such as glass, polyolefin, ultraviolet light curing resin, and other nontransparent materials other than polycarbonate may also be used for the protective substrate.

In the present embodiment, the substrate 2 and the substrate for ROM mark formation 33 were formed according to a method of coating an ultraviolet light curing resin by spin coating, while these substrates may be formed by attaching a sheet made of polycarbonate, polyolefin, or the like. Although this formation method is more time-consuming, radial nonuniformity in substrate thickness could be reduced.

### Second Embodiment

A second embodiment in which magnified marks are formed in a reading layer based on WO (write once) recording marks composed of a nucleation inducer as described above in (1) is explained.

(Composition and Manufacturing Method of Information Recording Medium of the Present Invention)

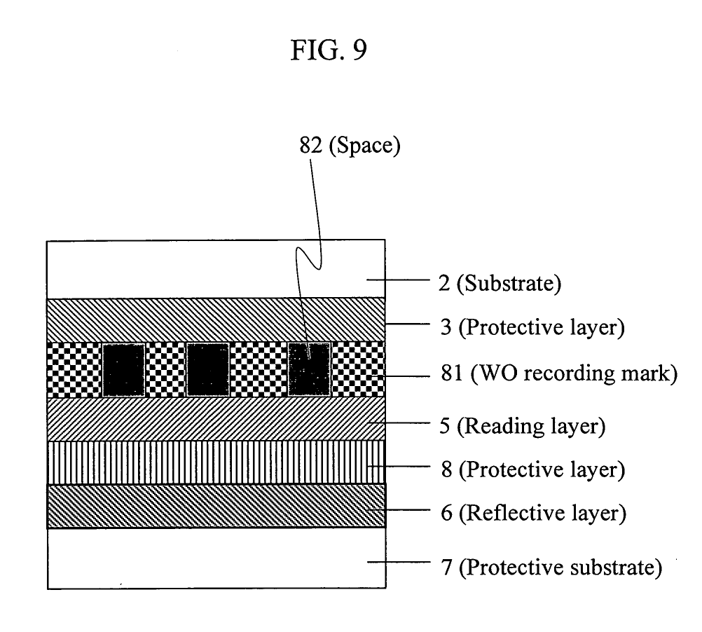

FIG. 9 depicts a cross sectional structure of a disk-shaped information recording medium of the second embodiment of the present invention. This medium was manufactured as follows:

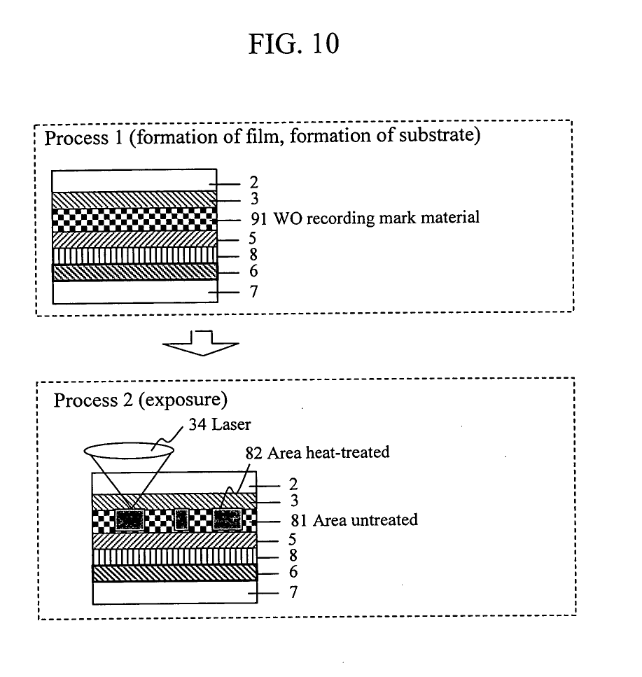

The processes for manufacturing the medium are shown in FIG. 10. First, in Process 1, the reflective layer 6 made of Ag₉₈Pd₁Cu₁ with a thickness of 200 nm, the protective layer 8 made of Cr₂O₃ with a thickness of 20 nm, the reading layer 5 made of Ge₆Sb₂Te₉ with a film thickness of 10 nm, a WO recording mark material 91 composed of Si—Te—N and Ti—N with a film thickness of 20 nm, and a protective layer 3 made of ZnS—SiO₂ with a thickness of 20 nm were formed in turn by sputtering over the polycarbonate protective substrate 7 having a diameter of 12 cm, a thickness of 1.1 mm, and grooves for tracking of land-groove recording with a track pitch of 0.2 μm on its surface.

Then, the substrate 2 with a thickness of ca. 0.1 μm was formed by spin coating an ultraviolet light curing resin.

In Process 2, the WO recording mark material 91 was locally heat-treated by recording pulses corresponding to recording information in the information recording apparatus provided with a laser 34. An area heat-treated 82 was brought to a state that Si and Ti were mixed together in the WO recording mark material 91 and that its one side contacting with the reading layer was hard to nucleate. On the other hand, an area untreated 81 was maintained in a state that nucleation was induced on its side contacting with the reading layer. In this way, the WO recording mark 81 was formed.

Although a laser with a wavelength of 405 nm and an aperture number of 0.85 was used here for the WO recording mark formation in Process 2, recording with a laser having a shorter wavelength or a larger number of aperture and heat treatment at a different linear velocity may be performed.

The substrate and the protective layer may also be formed after the heat treatment was carried out on the surface of the WO recording mark material without preforming the substrate and the protective layer. In this case, a method of heating by an electron beam irradiation or by a local electric current may also be employed besides the laser irradiation.

Although the heat treatment was carried out here so that the area heat-treated 82 became a space and the area untreated 81 became a mark, the treatment may be performed so that the area heat-treated becomes a mark. In this case, the combination for the WO recording mark material or the stacking order of layers must be changed so that a state of nucleation is induced by the heat treatment.

(Information Reproduction Method of the Present Invention)

When magnifying reading is conducted, a reading power is enhanced from a reading light to perform a focus tracking (Pf) to a magnifying reading power (Pr1) to crystallize the reading layer and allow to change its reflectivity. Since the reading layer of the present embodiment has a crystallization characteristic that it starts to crystallize from 130 degrees C. when in contact with a nucleation inducer, while it starts to crystallize from 200 degrees C. when not in contact with the nucleation inducer, its magnifying reading temperature should be at a temperature higher than 130 degrees C. and lower than 200 degrees C. When the WO mark with a recording mark size of 80 nm that was below the diffraction limit was read, an effect similar to the first embodiment was obtained.

(Comparison with a Conventional Example)

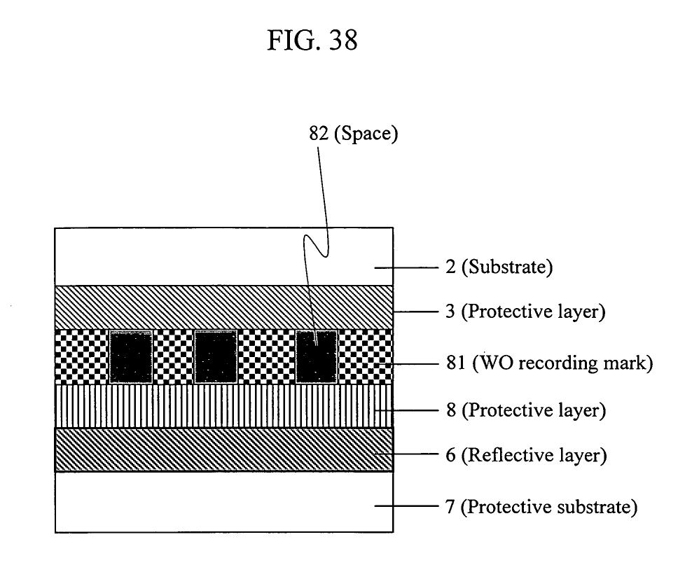

Next, the effect of magnifying reading was examined in comparison with a conventional example while changing the mark size, and the result is shown in Table 5. The effect of the magnifying reading represents the difference between both reading results. A WO disk in which there was no reading layer and its reflectivity change was caused by an interaction of two layers was used for the conventional example. The structure of the conventional medium is shown in FIG. 38. Recording on this medium was carried out by varying mark sizes and then read.

TABLE 5

| Mark | Reading result of | Magnifying reading | Effect of |
|---|---|---|---|
| size | conventional example | result of the invention | magnifying |
| (nm) | (dB) | (dB) | reading (dB) |
| 170 | 54 | 53 | −1 |
| 150 | 54 | 53 | −1 |
| 130 | 52 | 53 | 1 |
| 120 | 10 | 53 | 42 |
| 100 | No signal detected (0) | 51 | 51 |
| 80 | No signal detected (0) | 50 | 50 |
| 60 | No signal detected (0) | 45 | 45 |
| 40 | No signal detected (0) | 40 | 40 |

From the above, it is found that the effect of magnifying reading is prominent at 100 nm or lower where the mark size becomes smaller than the diffraction limit.

(Composition of Nucleation Inducer)

When CNR of signals from the disk in the second embodiment having a smallest mark size of 80 nm (2T) was measured while varying the nucleation inducer, the following result was obtained.

TABLE 6

| Nucleation inducer | State after heat treatment | |
|---|---|---|
| (reading layer side/distant side | (reading layer side/distant side | CNR |
| from reading layer) | from reading layer) | (dB) |
| Si—Te—N/Ti—N | Si—Ti/Si—Te—N, Ti—N | 51 |
| Bi—Te/Sn—Te—O | Bi—O/Sn—Te | 48 |
| Bi—Te—N/Sn—O | Bi—O/Sn—Te—N | 50 |
| Bi—Sb/Ta—O | Bi—O, Sb—O/Ta | 40 |

From this result, it was found that the recording mark was magnified and that an excellent signal having a CNR equal to or higher than 40 dB was obtained when mark and space were formed with the use of the above nucleation inducers.

A protective layer, reflective layer, substrate, information reproduction method, information reproduction apparatus, method for preparing magnifying reading, and the like, all of which are not described in the present embodiment, are the same as those in the first embodiment.

### Third Embodiment

A third embodiment in which magnified marks are formed in a reading layer based on ROM recording marks composed of a nucleation inducer as described above in (2) is explained.

(Composition and Manufacturing Method of Information Recording Medium of the Present Invention)

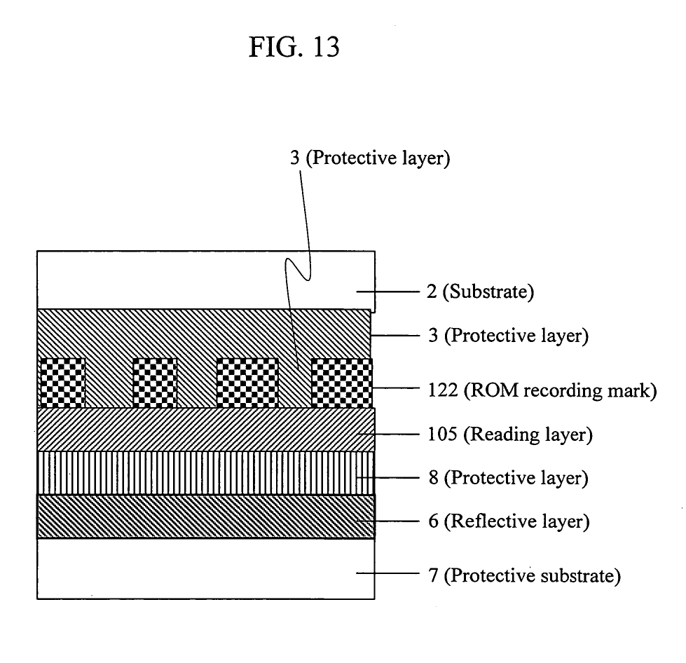

FIG. 13 depicts a cross sectional structure of a disk-shaped information recording medium of the third embodiment of the present invention.

The reflective layer 6 made of Ag₉₈Pd₁Cu₁ with a thickness of 200 nm, the protective layer 8 made of Cr₂O₃ with a thickness of 20 nm, a reading layer 105 made of Ge₅Sb₇₀Te₂₅ with a film thickness of 10 nm, a ROM recording mark material 122 composed of Sb—Bi with a film thickness of 20 nm, a protective layer 3 made of SiO₂ with a thickness of 20 nm, and the substrate 2 made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the first embodiment except for the material difference. Recording marks were formed by leaving Sb—Bi crystallized by the heat treatment, thereby forming marks and spaces.

(Information Reproduction Method of the Present Invention)

When magnifying reading is conducted, a reading power is enhanced from a reading light to perform a focus tracking (Pf) to a magnifying reading power (Pr2) to crystallize the reading layer and allow to change its reflectivity. Since the reading layer of the present embodiment has a crystallization characteristic that it starts to crystallize from 165 degrees C. when in contact with a crystal, while it starts to crystallize from 220 degrees C. when not in contact with the crystal, its magnifying reading temperature should be at a temperature higher than 165 degrees C. and lower than 220 degrees C.

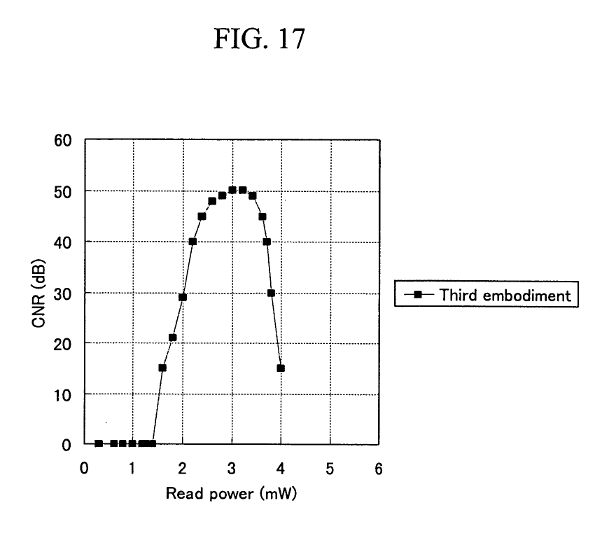

The ROM mark with a recording mark size of 80 nm that was below the diffraction limit was read. When CNR of the recording marks was examined by setting the Pf to 0.3 mW while varying the magnifying reading power (Pr2), reading results as shown in FIG. 17 were obtained.

When the Pr2 was 0.3 mW that was the same as the Pf, no signal from the mark could be detected. When the Pr2 was 2.2 mW that was higher than the Pf, a CNR of 40 dB was obtained. At 2.4 mW, 45 dB was obtained. A maximal CNR obtained was 50 dB. When the magnifying reading is conducted by shifting to a further higher power, 45 dB and 40 dB were obtained at 3.6 mW and 3.7 mW, respectively. Stable tracking can be conducted at the reading power for focus tracking ranging from 0.2 mW to 0.5 mW.

Thus, the relation between the reading power for focus tracking (Pf) and the magnifying reading power (Pr2) that gave an excellent magnifying reading characteristic was found to be expressed as below.
4×Pf≦Pr2
   (Composition of Crystalline Material)

When CNR of signals from the disk in the third embodiment having a mark size of 80 nm was measured while varying the ROM recording mark material (crystalline material), the following result was obtained.

TABLE 7

| Crystalline material | CNR (dB) |
|---|---|
| Sb—Bi | 50 |
| Ge—Te—N | 49 |
| Ge—N | 49 |
| Ge—Cr—N | 48 |
| Sb | 43 |
| Ta—N | 45 |
| Ta—O—N | 43 |
| Sn—Te—N | 49 |
| Si—O—N | 43 |
| Ag—Sb—Te | 42 |
| Ag—Te | 41 |
| W—O | 41 |
| Ta—O | 40 |
| Bi | 40 |
| Te | No signal detected (0) |

From this result, it was found that the recording mark was magnified and that an excellent signal having a CNR equal to or higher than 40 dB was obtained when recording marks were formed using as the crystalline material Sb—Bi, Ge—Te—N, Ge—N, Ge—Cr—N, Sb, Ta—N, Ta—O—N, Sn—Te—N, Si—O—N, Ag—Sb—Te, Ag—Te, W—O, Ta—O and Bi.

The effect of magnifying reading similar to the above result was also obtained even with crystalline materials not described here.

A reading layer, protective layer, reflective layer, substrate, information reproduction method, information reproduction apparatus, method for preparing magnifying reading, magnifying reading result and the like, all of which are not described in the present embodiment, are the same as those in the first and second embodiments.

### Fourth Embodiment

A fourth embodiment in which magnified marks are formed in a reading layer based on WO recording marks composed of a crystalline material as described above in (2) is explained.

(Composition and Manufacturing Method of Information Recording Medium of the Present Invention)

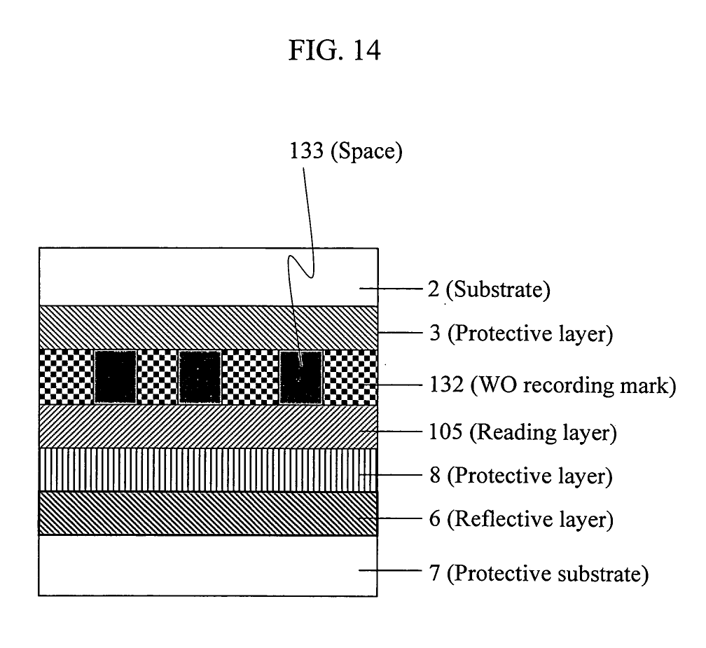

FIG. 14 depicts a cross sectional structure of a disk-shaped information recording medium of the fourth embodiment of the present invention.

The reflective layer 6 made of Ag₉₈Pd₁Cu₁ with a thickness of 200 nm, the protective layer 8 made of Cr₂O₃ with a thickness of 20 nm, the reading layer 105 made of Ge₅Sb₇₀Te₂₅ with a film thickness of 10 nm, a ROM recording mark material 122 composed of Al—Te with a film thickness of 20 nm, the protective layer 3 made of SiO₂ with a thickness of 20 nm, and the substrate 2 made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the first embodiment except for the material difference. Recording marks were formed by the heat treatment of Al—Te yielding crystalline area and non-crystalline area, where marks and spaces were formed.

The processes for manufacturing the medium are the same as those in the second embodiment except for a partial difference in materials used.

(Information Reproduction Method of the Present Invention)

When magnifying reading is conducted, a reading power is enhanced from a reading light to perform a focus tracking (Pf) to a magnifying reading power (Pr2) to crystallize the reading layer and allow to change its reflectivity.

When the WO mark with a recording mark size of 80 nm that was below the diffraction limit was read, a result similar to that in the third embodiment was obtained.

(Composition of Crystalline Material)

CNR of signals from the disk in the fourth embodiment having a mark size of 80 nm was measured while varying the crystalline material.

TABLE 8

| Crystalline material | CNR (dB) |
|---|---|
| Al—Te | 50 |
| Al—Te—N | 48 |
| Cu—Te—N | 46 |
| Cu—Te | 49 |

From this result, it was found that the recording mark was magnified and that an excellent signal having a CNR equal to or higher than 40 dB was obtained when Al—Te, Al—Te—N, Cu—Te, and Cu—Te—N were used for the crystalline material.

A reading layer, protective layer, reflective layer, substrate, information reproduction method, information reproduction apparatus, method for preparing magnifying reading, magnifying reading result and the like, all of which are not described in the present embodiment, are the same as those in the first to third embodiments.

### Fifth Embodiment

A fifth embodiment in which magnified marks are formed in a reading layer based on RAM recording marks composed of a crystalline material as described above in (2) is explained. It should be noted that the RAM recording mark means the recording mark that is rewritable.

(Composition and Manufacturing Method of Information Recording Medium of the Present Invention)

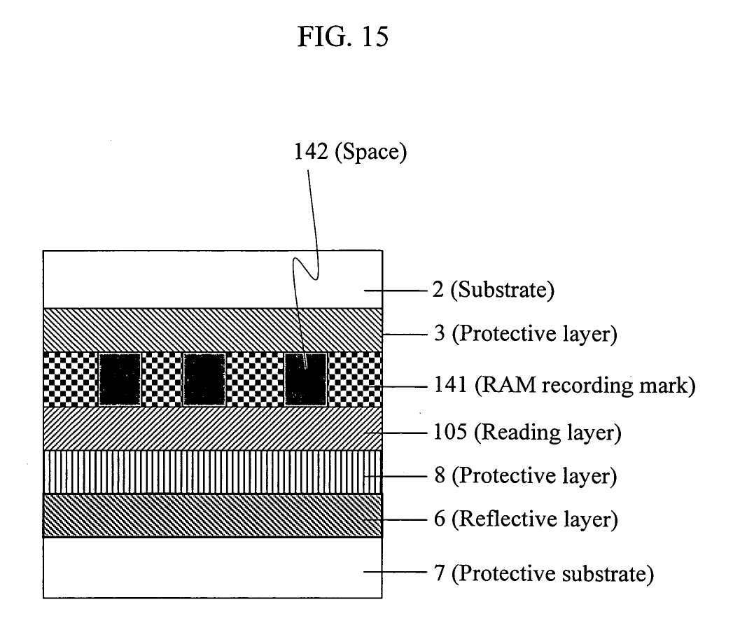

FIG. 15 depicts a cross sectional structure of a disk-shaped information recording medium of the fifth embodiment of the present invention. This medium was manufactured as follows:

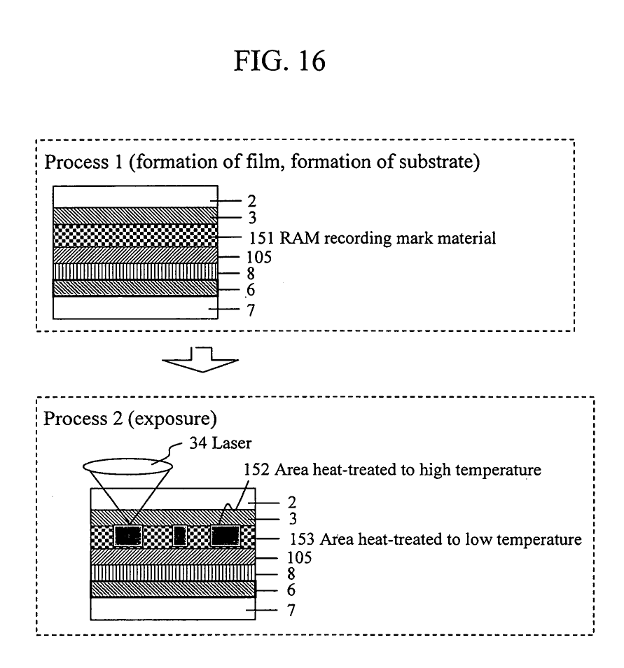

The processes for manufacturing the medium are shown in FIG. 16. First, in Process 1, the reflective layer 6 made of Ag₉₈Pd₁Cu₁ with a thickness of 200 nm, the protective layer 8 made of Cr₂O₃ with a thickness of 20 nm, a reading layer 105 made of Ge₁₅Sb₇₀Te₂₅ with a film thickness of 10 nm, a RAM recording mark material 151 composed of Ge—Te with a film thickness of 20 nm, and the protective layer 3 made of ZnS—SiO₂ with a thickness of 20 nm were formed in turn by sputtering over the polycarbonate protective substrate 7 having a diameter of 12 cm, a thickness of 1.1 mm, and grooves for tracking of land-groove recording with a track pitch of 0.2 μm on its surface. Then, the substrate 2 with a thickness of ca. 0.1 μm was formed by spin coating an ultraviolet light curing resin.

In Process 2, the RAM recording mark material 151 was locally heat-treated by recording pulses corresponding to recording information in the information recording apparatus provided with the laser 34. The RAM recording mark material 151 was amorphousized in an area heat-treated to high temperature 152 and crystallized in an area heat-treated to low temperature 153 by this heat treatment. In this way, RAM recording marks were formed.

Although the laser having a wavelength of 405 nm and an aperture number of 0.85 was used here for the RAM recording mark formation in Process 2, recording with a laser having a further shorter wavelength and a larger number of aperture, and heat treatment by varying a linear velocity may also be performed.

The substrate and the protective layer may be formed after the heat treatment was performed with placing the RAM recording mark material as a surface without forming the substrate and the protective layer. In this case, a method of heating by an electron beam irradiation, a local electric current, or the like may also be employed besides the laser irradiation.

Although the heat treatment here was carried out so that the area heat-treated to high temperature 152 became a space and the area heat-treated to low temperature 153 and became a mark, the treatment may also be carried out such that the area heat-treated to high temperature becomes a mark.

(Information Reproduction Method of the Present Invention)

When magnifying reading is conducted, a reading power is enhanced from a reading light to perform a focus tracking (Pf) to a magnifying reading power (Pr2) to crystallize the reading layer and allow to change its reflectivity. When the RAM mark with a recording mark size of 80 nm that was below the diffraction limit was read, a result similar to that in the third embodiment was obtained.

(Composition of Reading Layer 105)

When CNR of signals from the disk in the fifth embodiment having a mark size set to 80 nm was measured while varying the material for the reading layer 5, the result shown in Table 9 was obtained. The CNR shown here represents a maximum value within magnifying reading power. A range of the magnifying reading power showing a CNR equal to or higher than 40 dB was shown.

TABLE 9

| Material for reading layer | CNR (dB) | Magnifying reading power (mW) |
|---|---|---|
| Ge—Sb—Te | 51 | 1.2-3.2 |
| Ge—Bi—Te | 50 | 1.1-3.2 |
| Ge—Bi—Sb—Te | 49 | 1.2-3.3 |
| Ag—In—Sb—Te | 48 | 1.0-3.1 |
| Ag—In—Ge—Sb—Te | 47 | 1.1-3.1 |
| Ge—Sb—Te—O | 41 | 1.0-1.2 |
| Ge—Sb—Te—N | 41 | 1.3-1.5 |
| Sb | 30 | * |
| Ag—Sb | 15 | * |
| Bi—Sb | 10 | * |

* There was no power that produced a CNR equal to or higher than 40 dB.

The substrate and the protective layer may be formed after the heat treatment was performed with placing the RAM recording mark material as a surface without forming the substrate and the protective layer. In this case, a method of heating by an electron beam irradiation, a local electric current, or the like may also be employed besides the laser irradiation.

Although the heat treatment here was carried out so that the area heat-treated to high temperature 152 became a space and the area heat-treated to low temperature 153 became a mark, the treatment may also be carried out such that the area heat-treated to high temperature becomes a mark. When the content of any constituent element of the reading layer of the present embodiment deviated by 3 atomic % or more from the above compositions, crystallization speed became too fast or too slow, giving rise to a problem that shapes of magnified marks were distorted or the like. Accordingly, impurity elements are preferably less than 3 atomic %, and more preferably less than 1 atomic %.

(Composition of Crystalline Material)

When CNR of signals from the disk in the fifth embodiment having a mark size of 80 nm was measured while varying the RAM recording mark material 151 (crystalline material), the following result was obtained.

TABLE 10

| Crystalline material | CNR (dB) | Rewritable number (times) |
|---|---|---|
| Ge—Te | 47 | 500 |
| Ge—Te—N | 49 | 300 |
| Si—Te | 51 | 50 |
| Cu—Te | 51 | 5 |
| Ag—Te | 50 | 3 |
| Ag—Sb | 49 | 1 |

From this result, it was found that the recording mark is magnified and that an excellent signal having a CNR equal to or higher than 40 dB is obtained when recording marks are formed using as the crystalline material Ge—Te, Ge—Te—N, Si—Te, Cu—Te, Ag—Te, and Ag—Sb.

The effect of magnifying reading similar to the above result was also observed even with crystalline materials not described here. When the rewritable number of times was examined, Ge—Te and Ge—Te—N gave a result exceeding 100 times and were found to be excellent.

A protective layer, reflective layer, substrate, information reproduction method, information reproduction apparatus, method for preparing magnifying reading, magnifying reading result and the like, all of which are not described in the present embodiment, are the same as those in the first to fourth embodiments.

### Sixth Embodiment

A sixth embodiment in which magnified marks are formed in a reading layer based on WO recording marks with higher absorption as described above in (3) is explained.

(Composition and Manufacturing Method of Information Recording Medium of the Present Invention)

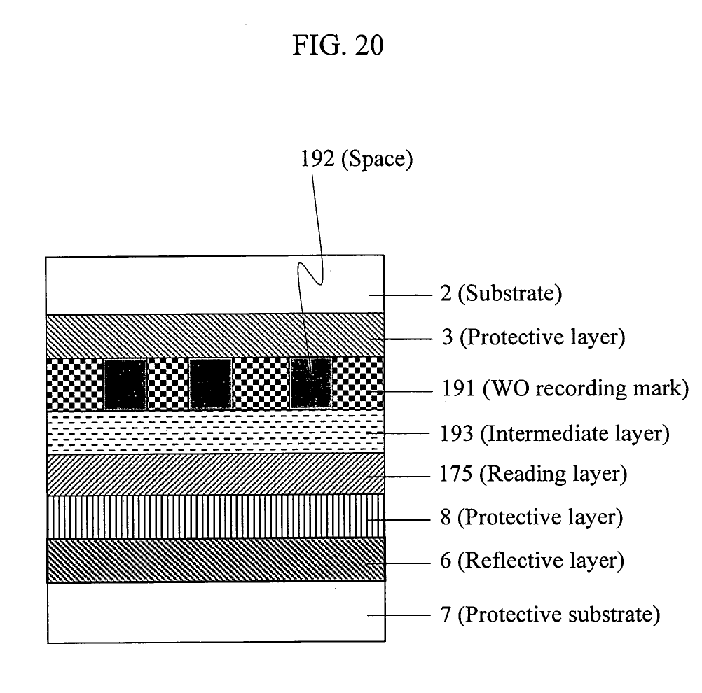

FIG. 20 depicts a cross sectional structure of a disk-shaped information recording medium of the sixth embodiment of the present invention.

The reflective layer 6 made of Ag₉₈Pd₁Cu₁ with a thickness of 200 nm, the protective layer 8 made of Cr₂O₃ with a thickness of 20 nm, a reading layer 175 made of Ge₅Sb₇₀Te₂₅ with a film thickness of 10 nm, an intermediate layer 193 made of Cr₂O₃ with a thickness of 2 nm, a WO recording mark material 191 composed of Ag and ZnS with a film thickness of 20 nm, the protective layer 3 made of ZnS—SiO₂ with a thickness of 30 nm, and the substrate 2 formed by spin coating an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the second embodiment except that the intermediate layer is formed between the reading layer and the WO recording mark material in Process 1. Recording marks and spaces were formed by reacting Ag and ZnS to AgS by the heat treatment in Process 2 to give rise to absorption change. In this way, WO recording marks 191 composed of Ag and ZnS, and spaces 192 containing AgS were formed.

Although the heat treatment was carried out here such that the area heat-treated became a space and the area untreated became a mark, the treatment may also be carried out such that the area heat-treated becomes a mark. In this case, the material of a layer to react with or to be diffused as the WO recording mark material must be changed to increase the absorption by the heat treatment.

(Method for Preparing Magnifying Reading)

The reading layer 5 of the disk manufactured as described above was subjected to an initial crystallization in the following way. The information recording medium disk was rotated at a linear velocity of 5 m/s, and the reading layer 5 was irradiated by a 3 mW pulse light with a width less than one half the window width (Tw) to carry out an initial crystallization. An elliptic beam may also be used for the crystallization. The reading layer crystallized during the course of cooling down when the spot passed after magnifying reading in the magnifying reading method of the present embodiment, which is different from the first to fifth embodiments and a fifteenth to nineteenth embodiments. Therefore, there was no need to prepare for reading for every magnifying reading.

(Information Reproduction Method and Information Reproduction Apparatus)

The information reproduction apparatus used is the same as that in the first embodiment except that a high power level of 10 mW, an intermediate power level of 3 mW, and a low power level of 0.5 mW were employed for the recording pulses.

(Information Reproduction Method of the Present Invention)

When magnifying reading is conducted, a reading power is enhanced from a reading light to perform a focus tracking (Pf) to a magnifying reading power (Pr3) to amorphousize the reading layer and allow to change its reflectivity. When the temperature reaches the melt temperature, the reading layer melts (amorphousize). The melt temperature is higher than ca. 540 degrees C. The temperature becomes higher in the area with higher absorption (recording mark) compared to the area with low absorption (other than recording mark), and amorphousization starts from the area with a lower reading power. Since the temperature of the recording mark area and its vicinity rises, the amorphousization takes place in an area larger than the recording mark.

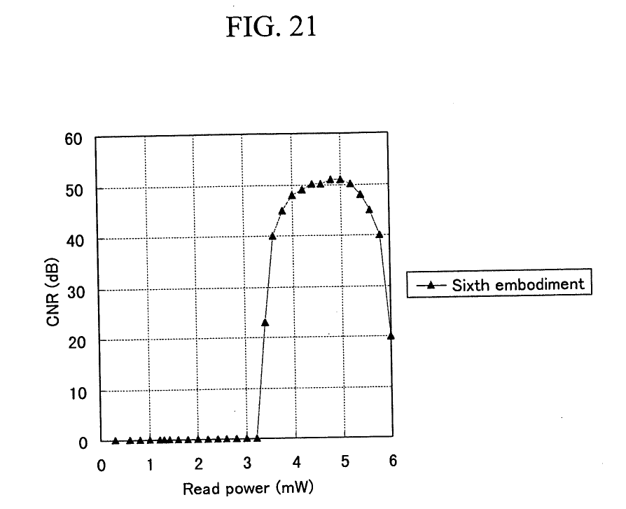

The ROM mark with a recording mark size of 80 nm that was below the diffraction limit was read. The Pf was set to 0.3 mW. When CNR of the recording mark was examined while changing the magnifying reading power (Pr3), reading results as shown in FIG. 21 were obtained. When the Pr3 was 0.3 mW that was the same as the Pf, no signal from the mark could be detected. When the Pr3 was 3.6 mW that was higher than the Pf, a CNR of 40 dB was obtained. At 3.8 mW, 45 dB was obtained. A maximal CNR obtained was 51 dB. When the magnifying reading was conducted by shifting to a further higher power, 45 dB and 40 dB were obtained at 5.6 mW and 5.8 mW, respectively. Stable tracking can be conducted at the reading power for focus tracking ranging from 0.2 mW to 0.5 mW.

The relation between the reading power for focus tracking (Pf) and the magnifying reading power (Pr3) that gives an excellent magnifying reading characteristic was found to be expressed as below.
7×Pf≦Pr3
   (Comparison with a Conventional Example)

Next, the effect of magnifying reading was examined in comparison with a conventional example while changing the mark size, and the result is shown in Table XI. The effect of the magnifying reading represents the difference between both reading results.

A WO disk in which there was no reading layer and the reflectivity was changed by a reaction between two layers was used as the conventional example. The structure of the conventional medium is shown in FIG. 38. This medium was recorded by varying its mark size, and then read.

TABLE 11

| | Reading result | Magnifying | Effect of |
|---|---|---|---|
| Mark | of conventional | reading result of | magnifying |
| size | example | the invention | reading |
| (nm) | (dB) | (dB) | (dB) |
| 170 | 55 | 54 | −1 |
| 150 | 55 | 54 | −1 |
| 130 | 53 | 54 | 1 |
| 120 | 10 | 53 | 43 |
| 100 | No signal detected (0) | 53 | 53 |
| 80 | No signal detected (0) | 51 | 51 |
| 60 | No signal detected (0) | 45 | 45 |
| 40 | No signal detected (0) | 40 | 40 |

From these results, it is found that the effect of magnifying reading is prominent at 100 nm or lower where the mark size becomes smaller than the diffraction limit.

In addition, when the size was examined where the recording mark was magnified, the magnifying recording mark size in the spot traveling direction did not become larger than the spot size.

(Composition of Reading Layer 175)

When CNR of signals from the disk in the sixth embodiment having a mark size set to 80 nm was measured while varying the material for the reading layer 175, the result shown in Table 12 was obtained. The CNR shown here represents a maximum value within magnifying reading power. A range of the magnifying reading power showing a CNR equal to or higher than 40 dB was shown.

TABLE 12

| Material for | | Magnifying reading |
|---|---|---|
| reading layer | CNR (dB) | power (mW) |
| Ge—Sb—Te | 51 | 3.6-5.8 |
| Ge—Bi—Te | 50 | 3.8-6.5 |
| Ge—Bi—Sb—Te | 49 | 3.8-6.5 |
| Ag—In—Sb—Te | 48 | 2.9-5.1 |
| Ag—In—Ge—Sb—Te | 47 | 2.9-5.1 |
| Ge—Sb—Te—O | 43 | 2.8-5.1 |
| Ge—Sb—Te—N | 41 | 3.8-5.8 |
| Sb | 30 | * |
| Ag—Sb | 15 | * |
| Bi—Sb | 10 | * |
| Ag—Te | No signal detected (0) | None |
| No reading layer | No signal detected (0) | None |

* There was no reading power that produced a CNR equal to or higher than 40 dB.

From the above result, it was found that the recording mark was magnified and that an excellent signal having a CNR equal to or higher than 40 dB was obtained when recording marks were formed using as the material for the reading layer Ge—Sb—Te, Ge—Bi—Te, Ag—In—Ge—Sb—Te, Ge—Te, Ag—In—Sb—Te, Ge—Bi—Sb—Te, Ge—Sb—Te—O, and Ge—Sb—Te—N. Among them, Ge—Sb—Te, Ge—Bi—Te, Ag—In—Ge—Sb—Te, Ge—Te, Ag—In—Sb—Te, and Ge—Bi—Sb—Te gave a CNR equal to higher than 45 dB and were more desirable.

Further, Ag—In—Sb—Te and Ge—Sb—Te—O were found to have good reading sensitivity at a lower reading power. Furthermore, it was found that Ge—Bi—Te and Ge—Bi—Sb—Te had a range of magnifying reading power of 2.7 mW, respectively, and thus their stability in magnifying reading was excellent.

An effect of magnifying reading similar to the above result was also observed for phase-change materials not described here that were materials of a type having properties of amorphousization and reflectivity change.

When the content of any constituent element of the reading layer deviated by 3 atomic % or more from the above compositions, crystallization speed became too fast or too slow, giving rise to a problem that shapes of magnified marks were distorted. Accordingly, impurity elements are preferably less than 3 atomic %, and more preferably less than 1 atomic %.

(Composition of Absorption Change Materials)

When CNR of signals from the disk in the sixth embodiment having the mark size set to 80 nm was measured while varying the combination of absorption change materials 174, the following result was obtained.

TABLE 13

| Untreated state | Post-heat treatment state | CNR (dB) |
|---|---|---|
| Ag, ZnS | AgS, ZnS, Zn | 51 |
| Co, ZnS | CoS, ZnS, Zn | 50 |
| Cu, Si | Cu—Si | 47 |
| Al, Si | Al—Si | 49 |
| Ti, Si | TiSi, TiSi | 48 |
| Ge, Si | Ge—Si | 43 |
| WO₃, TaOx | WOx, Ta₂O₅ | 45 |
| WO₃, IrOx | WOx, IrOx | 43 |
| TiO₂ | TiOx | 41 |
| TaOx | Ta₂O₅ | 42 |

From these results, it was found that the recording mark was magnified and that an excellent signal having a CNR equal to or higher than 40 dB was obtained when the above listed materials were used as the absorption change materials. When their post-heat treatment states were examined, the above results were obtained.

The method for changing absorption by heat treatment includes chemical reactions such as oxidation, combination, and reduction, diffusion, alloying, and the like, and any method was found to be applied as long as absorption change occurred.

Among them, oxidation reduction reaction and the like with the use of WO₃, TaOx, and the like having a higher temperature for the change were found to be excellent in stability and result in a larger number of readable cycles. On the other hand, it was learnt that, when the temperature for the change was too high, the power for recording became too high, resulting in an increase of noises caused by diffusion and reaction of the material for the protective layer and deformation of the substrate at the time of recording. When the reading power was 7 mW or lower, the noise increase was desirably lower than 5 dB. When the reading power was 6 mW or lower, the noise increase was more desirably lower than 3 dB.

(Intermediate Layer)

The replacement of Cr₂O₃ in the above intermediate layer 193 with any material of SnO₂, ZnS—SiO₂, Ta—O, and a mixture thereof gave comparable results.

The effect of magnifying reading similar to the above result was also obtained by other materials for the intermediate layer not described here.

The effect of magnifying reading can be achieved even though the intermediate layer 193 is not formed. However, the magnifying readable cycles decrease by one order of magnitude.

(Protective Layer)

The replacement of Cr₂O₃ in the above protective layer 8 with any material of SnO₂, ZnS—SiO₂, Ta—O, and a mixture thereof gave comparable results.

The effect of magnifying reading similar to the above result was also obtained by other materials for the protective layer not described here.

The effect of magnifying reading can be achieved even though the protective layer 8 is not formed. However, the magnifying readable cycles decrease by two orders of magnitude.

Further, part of the above absorption change materials and the protective layer can be combined. For example, this applies to a case where the protective layer is ZnS and the absorption change materials are Ag and ZnS, a case where the protective layer is Ta—O and the absorption change materials are Ta—O and WO₃, or the like. In these cases, part of the absorption change materials and the protective layer are continuously formed, thereby shortening the process of formation of film and reducing the cost.

(Composition of the Reflective Layer 6)

The replacement of AgPdCu in the above reflective layer 6 with any of an Ag compound, Al compound, Au compound, Cr compound, and a mixture thereof gave comparable results.

The effect of magnifying reading similar to the above result was also obtained by other materials for the reflective layer not described here.

The effect of magnifying reading can be achieved even though the reflective layer 6 is not formed. However, heat generated at the time of heat treatment to form the recording mark tends to be trapped, giving rise to variations in forming small recording marks and reduction in CNR by ca. 5 dB.

A reading layer, protective layer, materials for reflective layer, information reproduction method, information reproduction apparatus, method for preparing magnifying reading, evaluation method and the like, all of which are not described in the present embodiment, are the same as those in the first to fifth embodiments.

### Seventh Embodiment

A seventh embodiment in which magnified marks are formed in a reading layer based on ROM recording marks with higher absorption as described above in (3) is explained.

(Composition and Manufacturing Method of Information Recording Medium of the Present Invention)

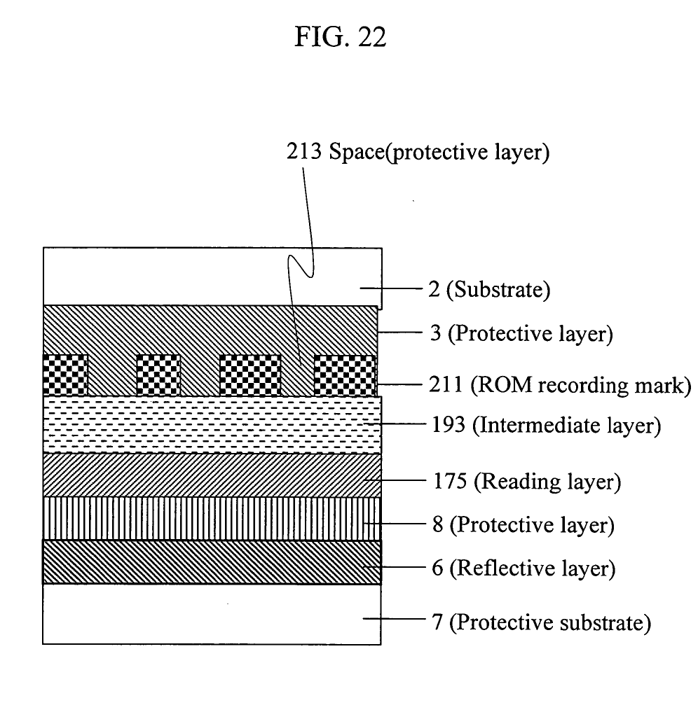

FIG. 22 depicts a cross sectional structure of a disk-shaped information recording medium of the seventh embodiment of the present invention.

The reflective layer 6 made of Ag₉₈Pd₁Cu₁ with a thickness of 200 nm, the protective layer 8 made of Cr₂O₃ with a thickness of 20 nm, a reading layer 5 made of Ge₅Sb₇₀Te₂₅ with a film thickness of 10 nm, the intermediate layer 193 made of Cr₂O₃ with a thickness of 2 nm, a ROM recording mark material 211 composed of Bi—Te—N with a film thickness of 20 nm, the protective layer 3 made of ZnS—SiO₂ with a thickness of 30 nm, and the substrate 2 composed of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface. The processes for manufacturing the medium are the same as those in the first embodiment except that materials and the intermediate layer were added.

(Information Reproduction Method of the Present Invention)

When magnifying reading is conducted, a reading power is enhanced from a reading light to perform a focus tracking (Pf) to a magnifying reading power (Pr3) to amorphousize the reading layer and allow to change its reflectivity. When the ROM mark with a recording mark size of 80 nm that was below the diffraction limit was read, a result similar to that in the embodiment 6 was obtained.

(Composition of Material with Absorption Different from that of Protective Layer)

When CNR of signals from the disk in the seventh embodiment having a mark size set to 80 nm was measured while varying the ROM recording mark material (material with absorption different from that of the protective layer), the following result was obtained.

TABLE 14

| Material with absorption different | |
|---|---|
| from that of protective layer | CNR (dB) |
| Bi—Te—N | 51 |
| Sn—Te—N | 50 |
| Ge—N | 49 |
| Ge—Cr—N | 48 |
| Ta—N | 45 |
| Sn—Te—N | 49 |
| Si | 43 |
| Sn—Te | 46 |
| Bi—Te | 48 |
| Bi—Sb | 47 |
| Cr—N | 42 |
| Sn—N | 41 |
| Ta | 40 |

From this result, it was found that the recording mark was magnified and that an excellent signal having a CNR equal to or higher than 40 dB was obtained when Bi—Te—N, Sn—Te—N, Ge—N, Ge—Cr—N, Ta—N, Si, Sn—Te, Bi—Te, Bi—Sb, Cr—N, Sn—N and Ta were used as the material with absorption different from that of the protective layer to form recording marks.

The effect of magnifying reading comparable to the above result was also obtained with other absorption change materials not described here as long as those are different in absorption from that of the protective layer. In the case of ROM, it is unnecessary for the absorption to be changed by heating.

Although the heat treatment here was carried out so that the area heat-treated to high temperature 152 became a space and the area heat-treated to low temperature 151 became a mark, the treatment may also be carried out such that the area heat-treated to high temperature becomes a mark.

### Eighth Embodiment

An eighth embodiment in which magnified marks are formed in a reading layer based on RAM recording marks with larger absorption as described above in (3) is explained.

(Composition and Manufacturing Method of Information Recording Medium of the Present Invention)

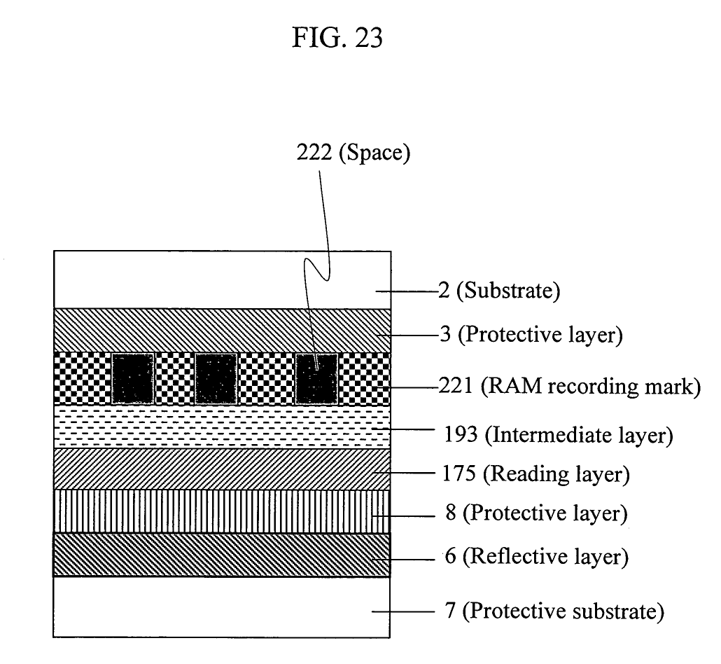

FIG. 23 depicts a cross sectional structure of a disk-shaped information recording medium of the present invention. The reflective layer 6 made of Ag₉₈Pd₁Cu₁ with a thickness of 200 nm, the protective layer 8 made of Cr₂O₃ with a thickness of 20 nm, a reading layer 175 made of Ge₅Sb₇₀Te₁₅ with a film thickness of 10 nm, the intermediate layer 193 made of Cr₂O₃ with a thickness of 2 nm, a RAM recording mark material composed of Si—Te with a film thickness of 20 nm, the protective layer 3 made of ZnS—SiO₂ with a thickness of 30 nm, and the substrate 2 formed by spin coating an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface. The processes for manufacturing the medium are the same as those in the fifth embodiment except that materials are different.

In Process 2, the RAM recording mark material was locally heat-treated by recording pulses corresponding to recording information in the information recording apparatus with the laser 34. By the heat treatment, the RAM recording mark material was amorphousized in the area heat-treated to high temperature and crystallized in the area heat-treated to low temperature. In this way, RAM recording marks 221 and spaces 222 were formed.

Although the heat treatment here was carried out so that the area heat-treated to high temperature became a space 222 and the area heat-treated to low temperature became a mark 221, the treatment may also be carried out such that the area heat-treated to high temperature becomes a mark.

(Information Reproduction Method of the Present Invention)

When magnifying reading is conducted, a reading power is enhanced from a reading light to perform a focus tracking (Pf) to a magnifying reading power (Pr3) to amorphousize the reading layer and allow to change its reflectivity. When the RAM mark with a recording mark size of 80 nm that was below the diffraction limit was read, a result similar to that in the sixth embodiment was obtained.

(RAM Recording Mark Material)

When CNR of signals from the disk in the eighth embodiment having a mark size set to 80 nm was measured while varying the RAM recording mark material (absorption change material), the following result was obtained.

TABLE 15

| Crystalline material | CNR (dB) | Rewritable number (times) |
|---|---|---|
| Ge—Te | 47 | 250 |
| Ge—Te—N | 49 | 150 |
| Si—Te | 51 | 20 |
| Cu—Te | 51 | 3 |
| Ag—Te | 50 | 2 |
| Ag—Sb | 49 | 1 |

From this result, it was found that the recording mark was magnified and that an excellent signal having a CNR equal to or higher than 40 dB was obtained when recording marks were formed using as the crystalline material Ge—Te, Ge—Te—N, Si—Te, Cu—Te, Ag—Te, and Ag—Sb. Among the effects of magnifying reading, CNR comparable to the above result was also observed with crystalline materials not described here.

When the rewritable number of times was examined, Ge—Te and Ge—Te—N gave a result exceeding 100 times, respectively, and were found to be excellent.

A protective layer, reflective layer, substrate, information reproduction method, information reproduction apparatus, method for preparing magnifying reading, magnifying reading result and the like, all of which are not described in the present embodiment, are the same as those in the first to seventh embodiments.

### Ninth Embodiment

A ninth embodiment in which magnified marks are formed in a reading layer based on WO recording marks with larger absorption as described above in (3) and the composition of the information recording medium differs from that in the sixth embodiment is explained.

(Composition and Manufacturing Method of Information Recording Medium of the Present Invention)

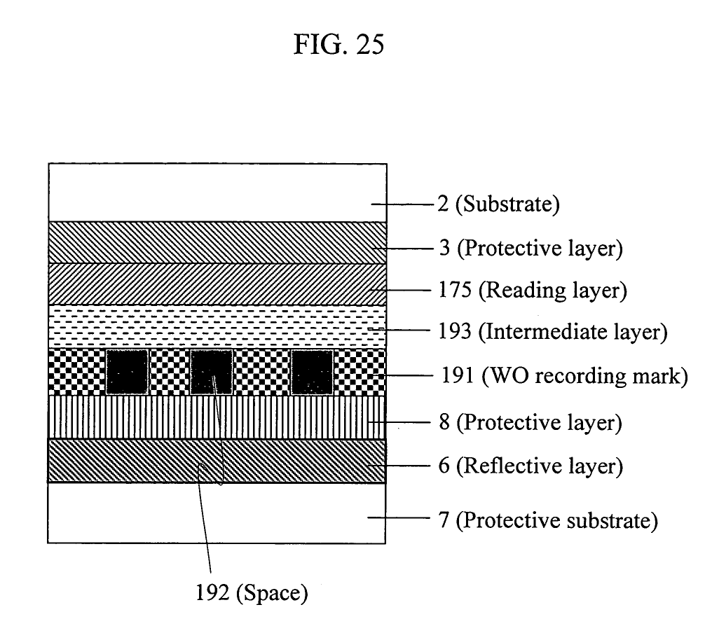

FIG. 25 depicts a cross sectional structure of a disk-shaped information recording medium of the ninth embodiment of the present invention.

The reflective layer 6 made of Ag₉₈Pd₁Cu₁ with a thickness of 200 nm, the protective layer 8 made of Cr₂O₃ with a thickness of 20 nm, a WO recording mark material composed of Bi—Te—N with a film thickness of 20 nm, the intermediate layer 193 made of Cr₂O₃ with a thickness of 2 nm, the reading layer 175 made of Ge₅Sb₇₀Te₂₅ with a film thickness of 10 nm, the protective layer 3 made of SiO₂ with a thickness of 20 nm, and the substrate 2 made of an ultraviolet light curing resin with a film thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface. The processes for manufacturing the medium are almost the same as those in the first embodiment except that materials and stacking order of layers are different.

(Information Reproduction Method of the Present Invention)

When magnifying reading is conducted, a reading power is enhanced from a reading light to perform a focus tracking (Pf) to a magnifying reading power (Pr2) to amorphousize the reading layer and allow to change its reflectivity. When the WO mark with a recording mark size of 80 nm that was below the diffraction limit was read, a result similar to that in the sixth embodiment was obtained.

A protective layer, reflective layer, substrate, information reproduction method, information reproduction apparatus, method for preparing magnifying reading, magnifying reading result and the like, all of which are not described in the present embodiment, are the same as those in the first to eighth embodiments.

### Tenth Embodiment

A tenth embodiment in which magnified marks are formed in a reading layer based on ROM recording marks with larger absorption as described above in (3) and the composition of the information recording medium differs from that in the seventh embodiment is explained.

(Composition and Manufacturing Method of Information Recording Medium of the Present Invention)

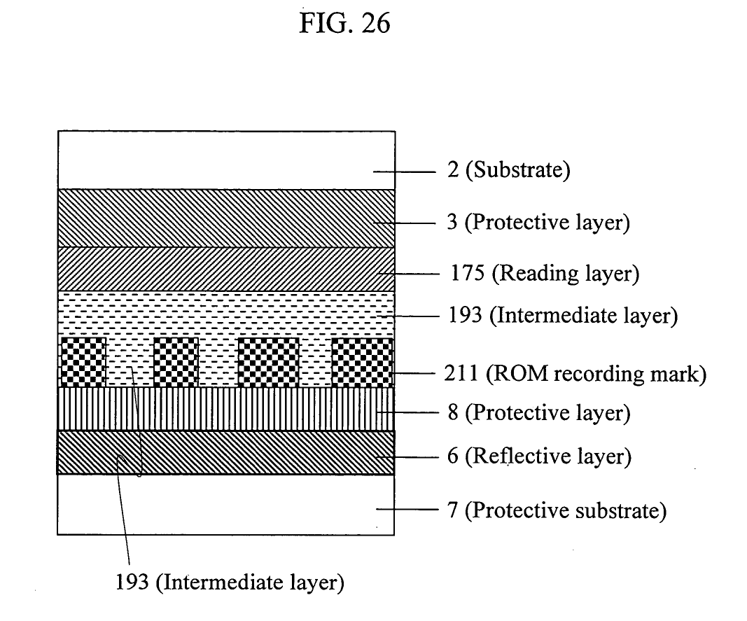

FIG. 26 depicts a cross sectional structure of a disk-shaped information recording medium of the tenth embodiment of the present invention.

The reflective layer 6 made of Ag₉₈Pd₁Cu₁ with a thickness of 200 nm, the protective layer 8 made of Cr₂O₃ with a thickness of 20 nm, a ROM recording mark material 211 composed of Bi—Te—N with a film thickness of 20 nm, the intermediate layer 193 made of Cr₂O₃ with a thickness of 2 nm, the reading layer 175 made of Ge₅Sb₇₀Te₂₅ with a film thickness of 10 nm, the protective layer 3 made of SiO₂ with a thickness of 20 nm, and the substrate made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface. The processes for manufacturing the medium are the same as those in the second embodiment except that materials and stacking order of layers are different.

(Information Reproduction Method of the Present Invention)

When magnifying reading is conducted, a reading power is enhanced from a reading light to perform a focus tracking (Pf) to a magnifying reading power (Pr1) to amorphousize the reading layer and allow to change its reflectivity. When the ROM mark with a recording mark size of 80 nm that was below the diffraction limit was read, a result similar to that in the seventh embodiment was obtained.

A protective layer, reflective layer, substrate, information reproduction method, information reproduction apparatus, method for preparing magnifying reading, magnifying reading result, and the like, all of which are not described in the present embodiment, are the same as those in the first to ninth embodiments.

### Eleventh Embodiment

An eleventh embodiment in which magnified marks are formed in a reading layer based on RAM recording marks with larger absorption as described above in (3) and the composition of the information recording medium differs from that in the eighth embodiment is explained.

(Composition and Manufacturing Method of Information Recording Medium of the Present Invention)

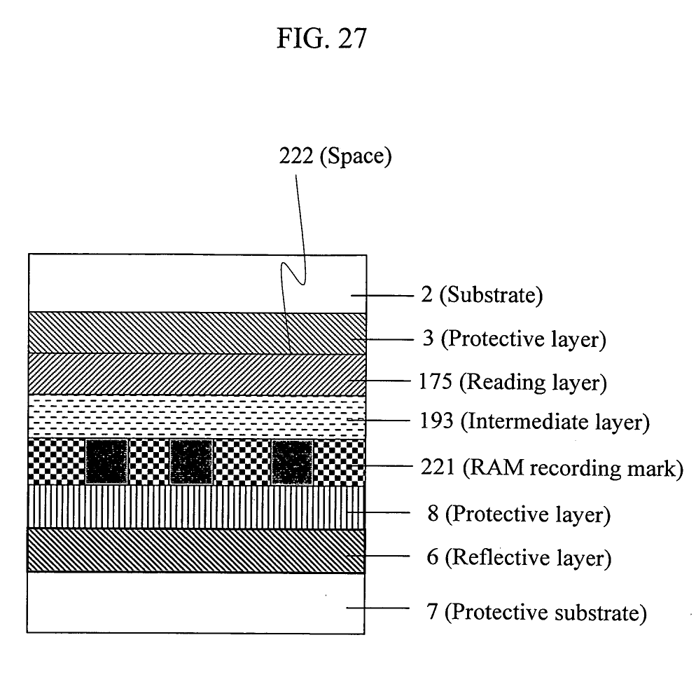

FIG. 27 depicts a cross sectional structure of a disk-shaped information recording medium of the eleventh embodiment of the present invention.

The reflective layer 6 made of Ag₉₈Pd₁Cu₁ with a thickness of 200 nm, the protective layer 8 made of Cr₂O₃ with a thickness of 20 nm, the reading layer 175 made of Ge₅Sb₇₀Te₁₅ with a film thickness of 10 nm, the intermediate layer 193 made of Cr₂O₃ with a thickness of 2 nm, a RAM recording mark material 221 composed of Si—Te with a film thickness of 20 nm, the protective layer 3 made of ZnS—SiO₂ with a thickness of 30 nm, and the substrate 2 formed by spin coating an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface. The processes for manufacturing the medium are the same as those in the fifth embodiment except that materials are different.

(Information Reproduction Method of the Present Invention)

When magnifying reading is conducted, a reading power is enhanced from a reading light to perform a focus tracking (Pf) to a magnifying reading power (Pr3) to amorphousize the reading layer and allow to change its reflectivity. When the RAM mark with a recording mark size of 80 nm that was below the diffraction limit was read, a result similar to that in the eighth embodiment was obtained.

A protective layer, reflective layer, substrate, information reproduction method, information reproduction apparatus, method for preparing magnifying reading, magnifying reading result, and the like, all of which are not described in the present embodiment, are the same as those in the first to ninth embodiments.

### Twelfth Embodiment

A twelfth embodiment in which magnified marks are formed in a reading layer based on WO recording marks with larger absorption as described above in (3) and the composition of the information recording medium differs from those in the sixth and ninth embodiments is explained.

(Composition and Manufacturing Method of Information Recording Medium of the Present Invention)

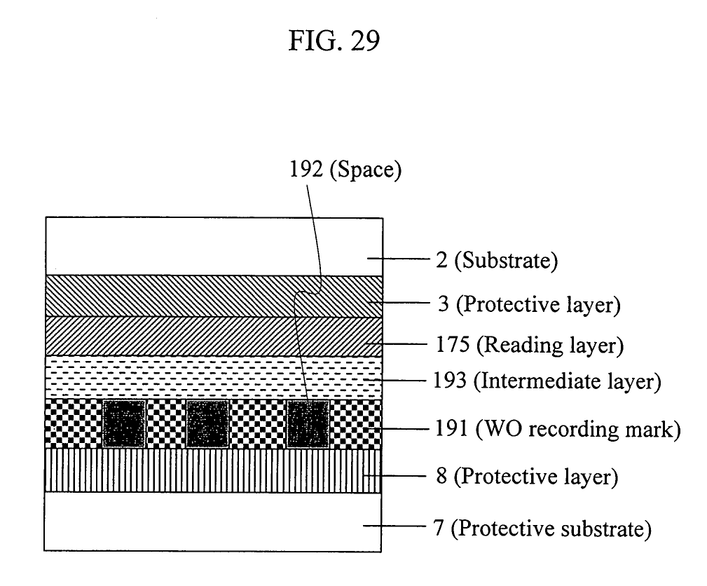

FIG. 29 depicts a cross sectional structure of a disk-shaped information recording medium of the twelfth embodiment of the present invention.

The protective layer 8 made of Cr₂O₃ with a thickness of 20 nm, a WO recording mark material 191 composed of Bi—Te—N with a film thickness of 20 nm, the intermediate layer 193 made of Cr₂O₃ with a thickness of 2 nm, the reading layer 175 made of Ge₅Sb₇₀Te₂₅ with a film thickness of 10 nm, the protective layer 3 made of SiO₂ with a thickness of 20 nm, and the substrate made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the first embodiment except that materials, stacking order of layers, and the absence of the reflective layer are different.

(Information Reproduction Method of the Present Invention)

When magnifying reading is conducted, a reading power is enhanced from a reading light to perform a focus tracking (Pf) to a magnifying reading power (Pr2) to amorphousize the reading layer and allow to change its reflectivity. When the RAM mark with a recording mark size of 80 nm that was below the diffraction limit was read, a result similar to that in the sixth embodiment was obtained.

A protective layer, reflective layer, substrate, information reproduction method, information reproduction apparatus, method for preparing magnifying reading, magnifying reading result, and the like, all of which are not described in the present embodiment, are the same as those in the first to eighth embodiments.

### Thirteenth Embodiment

A thirteenth embodiment in which magnified marks are formed in a reading layer based on ROM recording marks with larger absorption as described above in (3) and the composition of the information recording medium differs from those in the seventh and tenth embodiments is explained.

(Composition and Manufacturing Method of Information Recording Medium of the Present Invention)

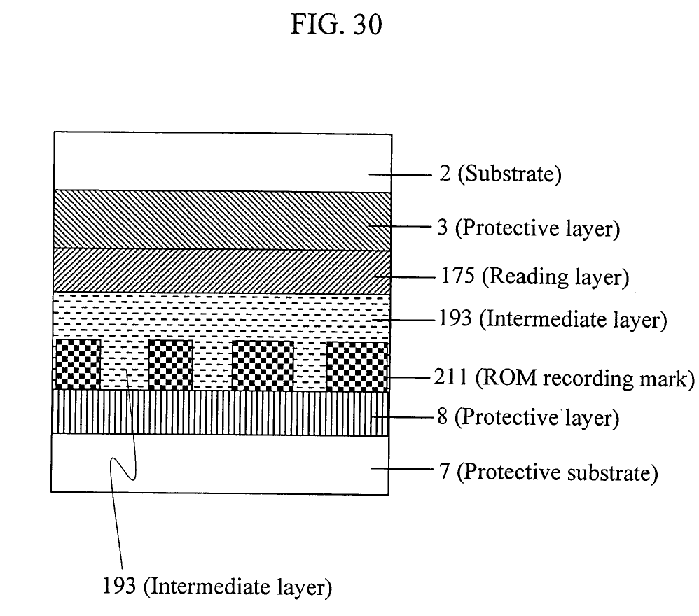

FIG. 30 depicts a cross sectional structure of a disk-shaped information recording medium of the thirteenth embodiment of the present invention.

The protective layer 8 made of Cr₂O₃ with a thickness of 20 nm, the ROM recording mark material 211 composed of Bi—Te—N with a film thickness of 20 nm, the intermediate layer 193 made of Cr₂O₃ with a thickness of 2 nm, the reading layer 175 made of Ge₅Sb₇₀Te₂₅ with a film thickness of 10 nm, the protective layer 3 made of SiO₂ with a thickness of 20 nm, and the substrate made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the first embodiment except that materials and stacking order of layers are different.

The processes are almost the same as those in the second embodiment except that materials, stacking order of layers, and the absence of the reflective layer only are different.

(Information Reproduction Method of the Present Invention)

When magnifying reading is conducted, a reading power is enhanced from a reading light to perform a focus tracking (Pf) to a magnifying reading power (Pr1) to amorphousize the reading layer and allow to change its reflectivity. When the RAM mark with a recording mark size of 80 nm that was below the diffraction limit was read, a result similar to that in the sixth embodiment was obtained.

A protective layer, reflective layer, substrate, information reproduction method, information reproduction apparatus, method for preparing magnifying reading, magnifying reading result and the like, all of which are not described in the present embodiment, are the same as those in the first to twelfth embodiments.

### Fourteenth Embodiment

A fourteenth embodiment in which magnified marks are formed in a reading layer based on RAM recording marks with larger absorption as described above in (3) and the composition of the information recording medium differs from those in the eighth and eleventh embodiments is explained.

(Composition and Manufacturing Method of Information Recording Medium of the Present Invention)

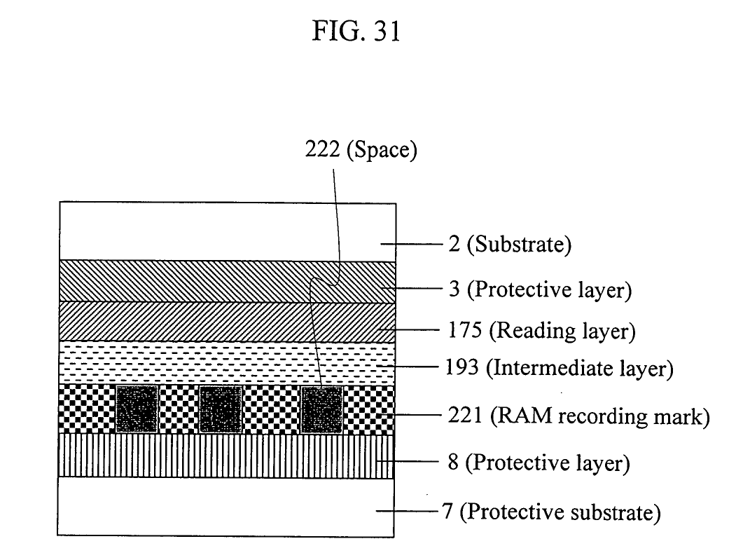

FIG. 31 depicts a cross sectional structure of a disk-shaped information recording medium of the fourteenth embodiment of the present invention.

The protective layer 8 made of Cr₂O₃ with a thickness of 20 nm, a RAM recording mark material composed of SiTe with a film thickness of 20 nm, the intermediate layer 193 made of Cr₂O₃ with a thickness of 2 nm, the reading layer 175 made of Ge₅Sb₇₀Te₁₅ with a film thickness of 10 nm, the protective layer 3 made of ZnS—SiO₂ with a thickness of 30 nm, and the substrate 2 formed by spin coating an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the fifth embodiment except that materials, stacking order of layers, and the absence of the reflective layer are different.

(Information Reproduction Method of the Present Invention)

When magnifying reading is conducted, a reading power is enhanced from a reading light to perform a focus tracking (Pf) to a magnifying reading power (Pr3) to amorphousize the reading layer and allow to change its reflectivity. When the RAM mark with a recording mark size of 80 nm that was below the diffraction limit was read, a result similar to that in the eighth embodiment was obtained.

A protective layer, reflective layer, substrate, information reproduction method, information reproduction apparatus, method for preparing magnifying reading, magnifying reading result, and the like, all of which are not described in the present embodiment, are the same as those in the first to thirteenth embodiments.

### Fifteenth Embodiment

A fifteenth embodiment in which magnified marks are formed in a reading layer based on ROM recording marks composed of a nucleation inducer as described above in (1) and the composition of the information recording medium differs from that in the first embodiment is explained.

(Composition and Manufacturing Method of Information Recording Medium of the Present Invention)

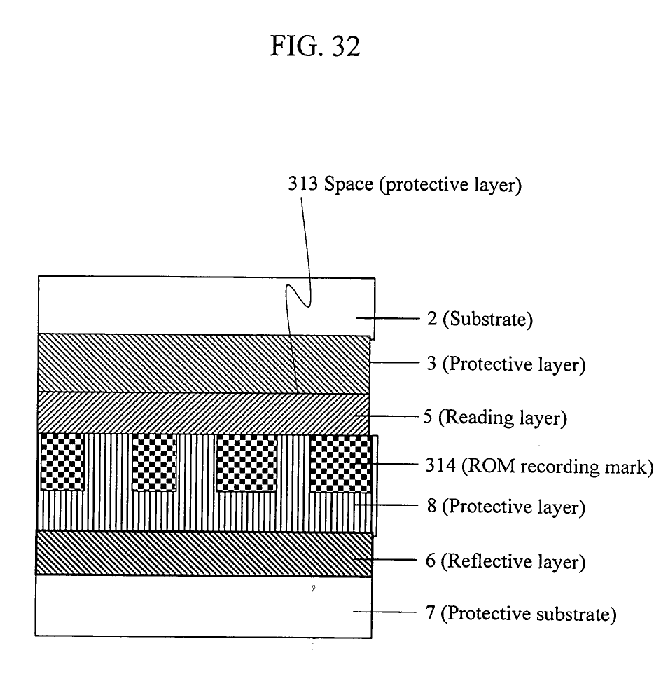

FIG. 32 depicts a cross sectional structure of a disk-shaped information recording medium of the fifteenth embodiment of the present invention.

The reflective layer 6 made of Ag₉₈Pd₁Cu₁ with a thickness of 200 nm, the protective layer 8 made of Cr₂O₃ with a thickness of 20 nm, a ROM recording mark material 314 composed of Bi—Te—N with a film thickness of 20 nm, a reading layer 5 made of Ge₈Sb₂Te₁₁ with a film thickness of 10 nm, the protective layer 3 made of SiO₂ with a thickness of 20 nm, and the substrate made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the first embodiment except that materials and stacking order of layers are different.

(Information Reproduction Method of the Present Invention)

When magnifying reading is conducted, a reading power is enhanced from a reading light to perform a focus tracking (Pf) to a magnifying reading power (Pr1) to amorphousize the reading layer and allow to change its reflectivity. When the RAM mark with a recording mark size of 80 nm that was below the diffraction limit was read, a result similar to that in the first embodiment was obtained.

A reading layer, nucleation inducer, protective layer, reflective layer, substrate, information reproduction method, information reproduction apparatus, method for preparing magnifying reading, magnifying reading result and the like, all of which are not described in the present embodiment, are the same as those in the first embodiment.

### Sixteenth Embodiment

A sixteenth embodiment in which magnified marks are formed in a reading layer based on WO recording marks composed of a nucleation inducer as described above in (1) and the composition of the information recording medium differs from that in the second embodiment is explained.

(Composition and Manufacturing Method of Information Recording Medium of the Present Invention)

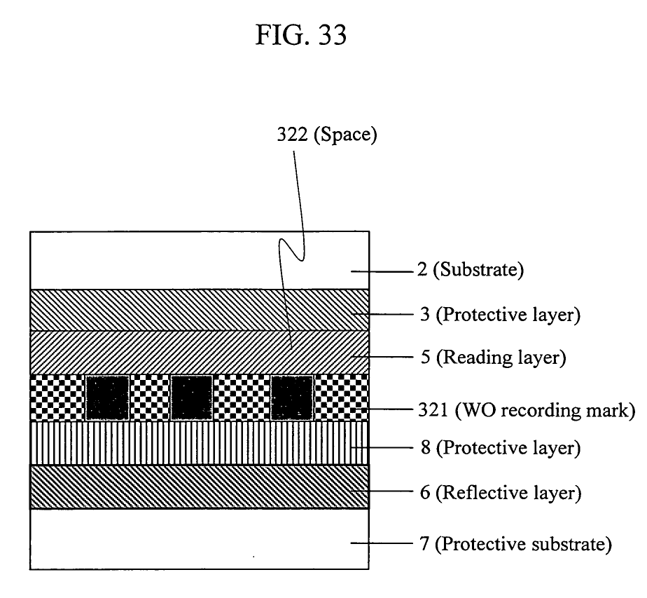

FIG. 33 depicts a cross sectional structure of a disk-shaped information recording medium of the sixteenth embodiment of the present invention.

The reflective layer 6 made of Ag₉₈Pd₁Cu₁ with a thickness of 200 nm, the protective layer 8 made of Cr₂O₃ with a thickness of 20 nm, ROM recording marks and spaces composed of Si—Te—N and Ti—N with a film thickness of 20 nm, the reading layer 5 made of Ge₈Sb₂Te₁₁ with a film thickness of 10 nm, the protective layer 3 made of SiO₂ with a thickness of 20 nm, and the substrate made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the second embodiment except that materials and stacking order of layers are different.

(Information Reproduction Method of the Present Invention)

When magnifying reading is conducted, a reading power is enhanced from a reading light to perform a focus tracking (Pf) to a magnifying reading power (Pr1) to amorphousize the reading layer and allow to change its reflectivity. When the RAM mark with a recording mark size of 80 nm that was below the diffraction limit was read, a result similar to that in the second embodiment was obtained.

A reading layer, nucleation inducer, protective layer, reflective layer, substrate, information reproduction method, information reproduction apparatus, method for preparing magnifying reading, magnifying reading result, and the like, all of which are not described in the present embodiment, are the same as those in the first, second and fifteenth embodiments.

### Seventeenth Embodiment

A seventeenth embodiment in which magnified marks are formed in a reading layer based on ROM recording marks composed of a crystalline material as described above in (2) and the composition of the information recording medium differs from that in the third embodiment is explained.

(Composition and Manufacturing Method of Information Recording Medium of the Present Invention)

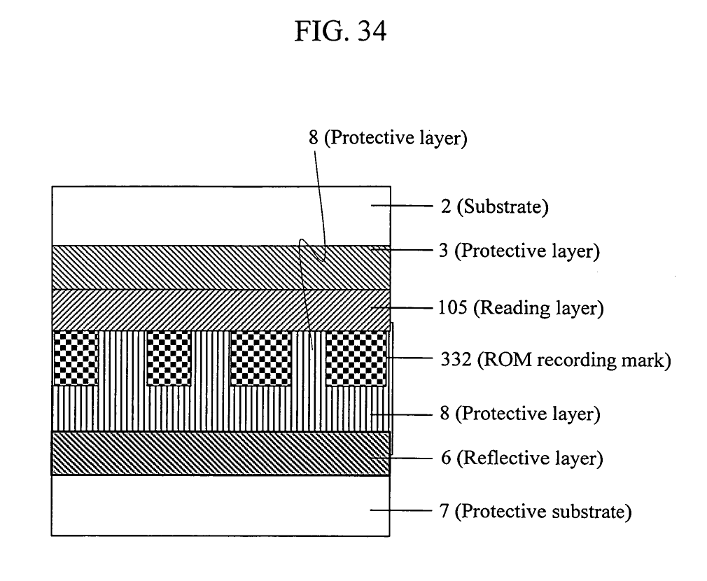

FIG. 34 depicts a cross sectional structure of a disk-shaped information recording medium of the seventeenth embodiment of the present invention.

The reflective layer 6 made of Ag₉₈Pd₁Cu₁ with a thickness of 200 nm, the protective layer 8 made of Cr₂O₃ with a thickness of 20 nm, a ROM recording mark material composed of Sb—Bi with a film thickness of 20 nm, the reading layer 105 made of Ge₅Sb₇₀Te₂₅ with a film thickness of 10 nm, the protective layer 3 made of SiO₂ with a thickness of 20 nm, and the substrate 2 made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are almost the same as those in the first embodiment except that materials and stacking order of layers are different.

(Information Reproduction Method of the Present Invention)

When magnifying reading is conducted, a reading power is enhanced from a reading light to perform a focus tracking (Pf) to a magnifying reading power (Pr2) to amorphousize the reading layer and allow to change its reflectivity. When the RAM mark with a recording mark size of 80 nm that was below the diffraction limit was read, a result similar to that in the second embodiment was obtained.

A reading layer, nucleation inducer, protective layer, reflective layer, substrate, information reproduction method, information reproduction apparatus, method for preparing magnifying reading, magnifying reading result and the like, all of which are not described in the present embodiment, are the same as those in the first, second, and fifteenth embodiments.

### Eighteenth Embodiment

A eighteenth embodiment in which magnified marks are formed in a reading layer based on WO recording marks composed of a crystalline material as described above in (2) and the composition of the information recording medium differs from that in the fourth embodiment is explained.

(Composition and Manufacturing Method of Information Recording Medium of the Present Invention)

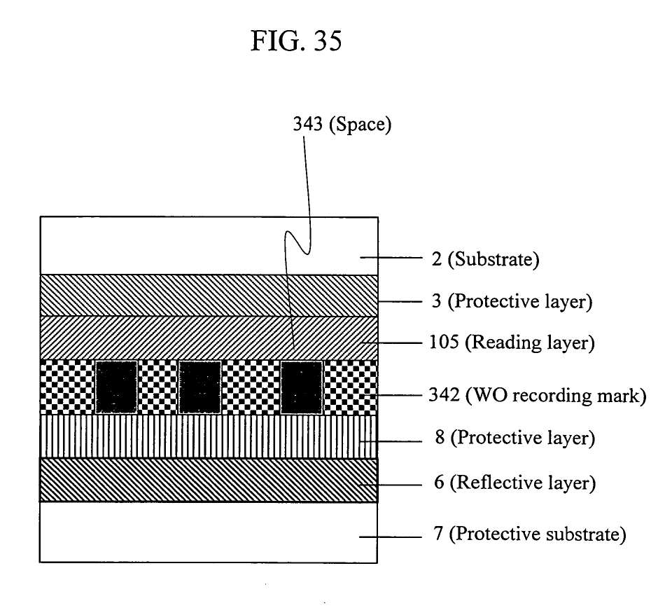

FIG. 35 depicts a cross sectional structure of a disk-shaped information recording medium of the eighteenth embodiment of the present invention.

The reflective layer 6 made of Ag₉₈Pd₁Cu₁ with a thickness of 200 nm, the protective layer 8 made of Cr₂O₃ with a thickness of 20 nm, WO recording marks 342 and spaces composed of Al—Te with a film thickness of 20 nm, the reading layer 105 made of Ge₅Sb₇₀Te₂₅ with a film thickness of 10 nm, the protective layer 3 made of SiO₂ with a thickness of 20 nm, and the substrate 2 made of an ultraviolet light curing resin with a thickness of ca. 0.1 μm were formed over the polycarbonate protective substrate 7 having a diameter of 12 cm, a thickness of 1.1 mm, and grooves for tracking of land-groove recording with a track pitch of 0.2 μm on its surface.

The processes for manufacturing the medium are the same as those in the second embodiment except that materials are different.

Recording marks were formed by the heat treatment of Al—Te yielding crystalline area and non-crystalline area, where marks and spaces were formed.

The processes for manufacturing the medium are the same as those in the second embodiment except that part of materials and stacking order of layers are different.

(Information Reproduction Method of the Present Invention)

When magnifying reading is conducted, a reading power is enhanced from a reading light to perform a focus tracking (Pf) to a magnifying reading power (Pr2) to amorphousize the reading layer and allow to change its reflectivity. When the RAM mark with a recording mark size of 80 nm that was below the diffraction limit was read, a result similar to that in the second embodiment was obtained.

A reading layer, nucleation inducer, protective layer, reflective layer, substrate, information reproduction method, information reproduction apparatus, method for preparing magnifying reading, magnifying reading result and the like, all of which are not described in the present embodiment, are the same as those in the third to fifth embodiments and the seventeenth embodiment.

### Nineteenth Embodiment

A nineteenth embodiment in which magnified marks are formed in a reading layer based on RAM recording marks composed of a crystalline material as described above in (2) and the composition of the information recording medium differs from that in the fifth embodiment is explained.

(Composition and Manufacturing Method of Information Recording Medium of the Present Invention)

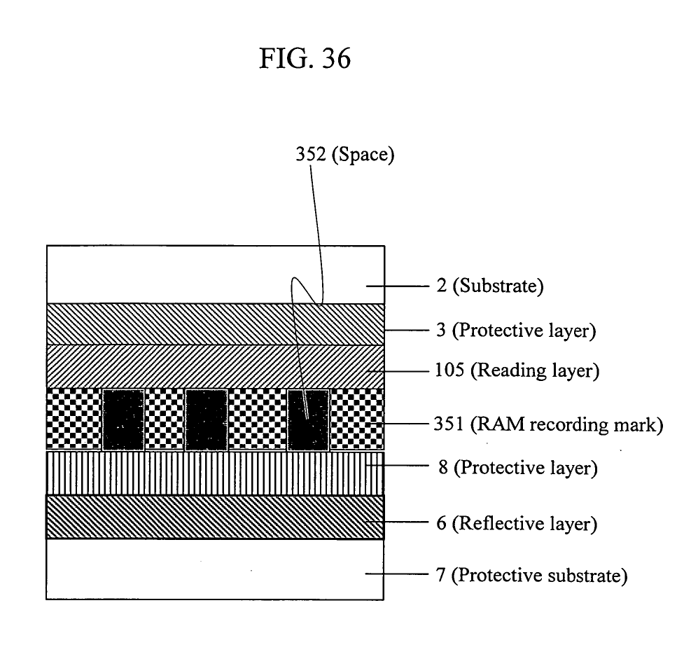

FIG. 36 depicts a cross sectional structure of a disk-shaped information recording medium of the nineteenth embodiment of the present invention. This medium was manufactured as follows.

The manufacturing method of the medium is shown in FIG. 16. First, in Process 1, the reflective layer 6 made of Ag₉₈Pd₁Cu₁ with a thickness of 200 nm, the protective layer 8 made of Cr₂O₃ with a thickness of 20 nm, the reading layer 105 made of Ge₁₅Sb₇₀Te₂₅ with a film thickness of 10 nm, the RAM recording mark material 151 composed of Ge—Te with a film thickness of 20 nm, and the protective layer 3 made of ZnS—SiO₂ with a thickness of 20 nm were formed in turn by sputtering over the polycarbonate protective substrate 7 having a diameter of 12 cm, a thickness of 1.1 mm, and grooves for tracking of land-groove recording with a track pitch of 0.2 μm on its surface.

Then, the substrate 2 was formed by spin coating an ultraviolet light curing resin with a thickness of ca. 0.1 μm.

(Information Reproduction Method of the Present Invention)

When magnifying reading is conducted, a reading power is enhanced from a reading light to perform a focus tracking (Pf) to a magnifying reading power (Pr3) to crystallize the reading layer and allow to change its reflectivity. When the RAM mark with a recording mark size of 80 nm that was below the diffraction limit was read, a result similar to that in the third embodiment was obtained.

A reading layer, nucleation inducer, protective layer, reflective layer, substrate, information reproduction method, information reproduction apparatus, method for preparing magnifying reading, magnifying reading result, and the like, all of which are not described in the present embodiment, are the same as those in the third to fifth embodiments and the sixteenth to eighteenth embodiments.

It should be noted that the term “phase-change” used in the present specification includes not only a phase-change between crystalline and amorphous states but also phase-changes between crystalline and melt states and between melt (conversion to liquid state) and re-crystallized states.

What is claimed is:

1. An information recording medium comprising:
a substrate;
a recording layer formed with recording marks consisting of a nucleation inducer; and
a reading layer,
wherein an area of the reading layer corresponding to the recording mark is crystallized in an area larger than the recording mark by irradiating a reading beam to the recording mark.

2. The information recording medium according to claim 1, wherein the area of the reading layer is crystallized with the trigger of the nucleation inducer of the recording mark.

3. The information recording medium according to claim 1, wherein the recording layer and the reading layer are in contact with each other.

4. The information recording medium according to claim 1, wherein the recording layer is provided between the substrate and the reading layer.

5. The information recording medium according to claim 1, wherein the reading layer is provided between the substrate and the recording layer.

6. The information recording medium according to claim 1, wherein the reading layer contains Te in the range of 15 atomic % or more but 60 atomic % or less, and the recording layer is any one of Bi—Te—N, Sn—Te—N, Ge—N, Ge—Cr—N, Ta—N, Ta—O—N, Sn—Te—N, Si—O—N, Sn—Te, Bi—Te, Bi—Sb, Cr—O, Sn—O, Ta—O, and Bi.

7. An information reproduction method comprising:
irradiating a reading beam to a recording medium provided with a recording layer formed with recording marks consisting of a nucleation inducer and a reading layer;
crystallizing an area of the reading layer corresponding to the recording mark in a plane direction such that the area becomes larger than the recording mark; and
reproducing information.

8. The information reproduction method according to claim 7 further comprising:
irradiating a second spot that makes the reading layer amorphous at the front or the back of the reading beam.

9. The information reproduction method according to claim 7, wherein the recording mark is a ROM type recording mark or a WO type recording mark.

10. An information recording medium comprising:
a substrate;
a recording layer formed with recording marks consisting of a crystalline material; and
a reading layer,
wherein an area of the reading layer corresponding to the recording mark is crystallized in an area larger than the recording mark by irradiating a reading beam to the recording mark.

11. An information reproduction method comprising:
irradiating a reading beam to a recording medium provided with a substrate, a recording layer formed with recording marks consisting of a crystalline material, and a reading layer; crystallizing an area of the reading layer corresponding to the recording mark in a plane direction such that the area becomes larger than the recording mark; and
reproducing information.

12. An information recording medium comprising:
a substrate;
a recording layer formed with recording marks with absorption larger than that in a non-recording region; and
a reading layer,
wherein an area of the reading layer corresponding to the recording mark is melted by irradiating a reading beam and the resulting melt region becomes larger than the recording mark.

13. The information recording medium according to claim 12, wherein the recording layer is provided between the substrate and the reading layer.

14. The information recording medium according to claim 12, wherein the reading layer is provided between the substrate and the recording layer.

15. The information recording medium according to claim 12, wherein a reflective layer is further provided.

16. The information recording medium according to claim 12, wherein the recording mark is any one of a ROM type, a WO type, and a RAM type recording mark.

17. The information recording medium according to claim 12, wherein an intermediate layer is provided between the recording layer and the reading layer.

18. An information reproduction method comprising:
irradiating a reading beam to a recording medium provided with a substrate, a recording layer formed with recording marks with absorption larger than that in a non-recording region and a reading layer;
melting an area of the reading layer corresponding to the recording mark in a plane direction such that the area becomes larger than the recording mark; and
reproducing information.

19. The information reproduction method according to claim 18, wherein the area of the reading layer corresponding to the recording mark is melted by heat conduction from the recording mark.

20. The information reproduction method according to claim 18, wherein the reading layer is crystallized after the reading beam passes.
